(19) United States
(12) Patent Application Publication
(10) Pub. No.: US 2016/0168724 A1
(43) Pub. Date: Jun. 16, 2016

(54) POLYVINYLBUTYRAL COATING CONTAINING THIOL CORROSION INHIBITORS

(71) Applicant: The Boeing Company, Huntington Beach, CA (US)

(72) Inventors: Patrick J. Kinlen, Fenton, MO (US); Melissa D. Cremer, Seattle, WA (US); Eileen K. Jackson, Seattle, WA (US); Ofer Alves, Kirkland, WA (US)

(21) Appl. No.: 14/571,272

(22) Filed: Dec. 15, 2014

(51) Int. Cl. C23F 11/00; B05D 1/00; C08K 5/46; B05D 1/02; C09D 5/08; C09D 137/00

(52) U.S. Cl. CPC C23F 11/00; C09D 5/086; C09D 137/00; C08K 5/46; B05D 1/02; B05D 1/005

(57) ABSTRACT

Formulations, coatings and methods for coating a corrosion inhibiting formulation on a substrate are provided. The corrosion inhibiting formulation includes (a) at least one resin, (b) at least one Brønsted acid and (c) at least one thio-containing corrosion inhibitor.

### FIELD

Corrosion inhibiting formulations and substrate coatings are described. In particular, the disclosure provides formulations and substrate coatings directed to polymer resins containing thiol corrosion inhibitors.

### BACKGROUND

Hexavalent chromium (Cr[VI]) compounds are potent inhibitors of corrosion. For the past 70 years, Cr[VI] compounds have been used in primers, coatings and sealants to prevent corrosion in metallic substrates and alloys. In the aerospace industry, Cr[VI] compounds are the most prevalent and effective corrosion inhibitor systems for coating aerospace aluminum alloys.

Yet Cr[VI] compounds are known carcinogens. Those who work with Cr[VI]-based corrosion inhibitor systems are subject to significant health risks. Government oversight and regulatory compliance with storage, maintenance, and disposal of Cr[VI] materials and waste impose additional burdens on industry.

A need exists for Cr[VI] replacement materials having corrosion inhibiting properties.

### BRIEF SUMMARY

In a first aspect, a corrosion inhibiting formulation is described. The corrosion inhibiting formulation includes (a) at least one resin, (b) at least one Brønsted acid and (c) at least one thio-containing corrosion inhibitor.

In a second aspect, a substrate coating including a corrosion inhibiting formulation is described. The corrosion inhibiting formulation includes (a) at least one resin, (b) at least one Brønsted acid and (c) at least one thio-containing corrosion inhibitor.

In a third aspect, a method of inhibiting corrosion on a substrate is described. The method includes two steps. The first step is disposing a coating onto the substrate. The coating includes a corrosion inhibiting formulation. The corrosion inhibiting formulation includes (a) at least one resin, (b) at least one Brønsted acid and (c) at least one thio-containing corrosion inhibitor. The second step includes curing the coating.

### BRIEF DESCRIPTION OF THE DRAWINGS

FIG. 1 depicts Laminar flow of electrolyte over the surface of the rotating disk working electrode.

FIG. 2 depicts exemplary data of open circuit potential of panel substrates having PVB coatings having 0% (wt/wt), 0.5% (wt/wt) or 5% (wt/wt) DMcT.

FIG. 3A depicts exemplary data of chronoamperometry of DMcT and Compound (II) (Vanlube 829) thio-containing corrosion inhibitors in PVB resin with no acid catalyst.

FIG. 3B depicts exemplary data of chronoamperometry of DMcT and Compound (II) (Vanlube 829) thio-containing corrosion inhibitors in PVB resin with acid catalyst.

FIG. 3C depicts exemplary data of chronoamperometry of DMcT and Compound (II) (Vanlube 829) thio-containing corrosion inhibitors in PVB resin with no acid catalyst, wherein the panel substrates were inscribed with a 1″ X before analysis.

FIG. 3D depicts exemplary data of chronoamperometry of 0.5% (wt/wt) Cu(DMcT)₂ thio-containing corrosion inhibitor in PVB resin with acid catalyst.

FIG. 3E depicts exemplary data of chronoamperometry of 0.5% (wt/wt) PANI thio-containing corrosion inhibitor in PVB resin.

### DETAILED DESCRIPTION

Certain terms are first defined. Additional terms are defined throughout the specification.

Terms used herein are intended as “open” terms. As used herein, open terms, such as “comprise,” “include” and “have” are used interchangeably throughout the specification.

The verb forms of “comprise,” “have” and “include,” have the same meaning as used herein. Likewise, the verb forms of “describe”, “disclose” and “provide” have the same meaning as used herein.

As used herein, the articles “a,” “an” and “the” refer to one or more than one (for example, to at least one) of the grammatical object of the article. Accordingly, the singular forms “a,” “an,” and “the” include plural referents unless the context clearly dictates otherwise.

“About” and “approximately” shall generally mean an acceptable degree of error for the quantity measured given the nature or precision of the measurements. Exemplary degrees of error are within 25 percent (%), typically, within 10%, and more typically, within 5% of a given value or range of values.

As used herein, “or” is used herein to mean, and is used interchangeably with, the term “and/or”, unless context clearly indicates otherwise. The use of the term “and/or” in some places herein does not mean that uses of the term “or” are not interchangeable with the term “and/or” unless the context clearly indicates otherwise.

All language such as “from,” “to,” “up to,” “at least,” “greater than,” “less than,” and the like, include the number recited and refer to ranges that can subsequently be broken down into sub-ranges as the context warrants.

A range includes each individual member. Thus, for example, a group having 1-3 members refers to groups having 1, 2, or 3 members. Similarly, a group having 6 members refers to groups having 1, 2, 3, 4, 5 or 6 members, and so forth.

The phrase “neat formulation” refers to a formulation consisting of a defined composition of specified components, wherein the total amount of the specified components of the defined composition sums to 100 weight-percent. A person of ordinary skill in the art will recognize that not all formulations are “neat formulations,” as a formulation can comprise a defined composition of specified components, wherein the total amount of the specified components of the defined composition sums to less than 100 weight-percent and a remainder of the formulation comprises other components, wherein the total amount of the specified components of the defined composition and the remainder sums to 100 weight-percent. The formulations disclosed herein sum to 100 weight-percent of the total amount of specified components and other components.

The chemical structures described herein are named according to IUPAC nomenclature rules and include art-accepted common names and abbreviations where appropriate. The IUPAC nomenclature can be derived with chemical structure drawing software programs, such as ChemDraw® (PerkinElmer, Inc.), ChemDoodle® (iChemLabs, LLC) and Marvin (ChemAxon Ltd.). Except for the predicted chemical structures of metal thiadiazoles depicted in Table 5, the chemical structure controls in the disclosure to the extent that an IUPAC name is misnamed or otherwise conflicts with the chemical structure disclosed herein.

Headings, for example, (a), (b), (i) etc., are presented merely for ease of reading the specification and claims. The use of headings in the specification or claims does not require the steps or elements be performed in alphabetical or numerical order or the order in that they are presented.

This disclosure relates to the development and implementation the technologies to eliminate hexavalent chromium (Cr⁶⁺) by identifying and qualifying non-hexavalent chromium alternatives for primers, conversion coatings and sealants. The synthesis of novel electroactive cathodic-thio systems including monomers, dimers, polymers and metal salts that inhibit oxygen reduction reactions are described. These inhibitor systems formulated into simple resin systems such as poly(vinylbutyral) (PVB) that may be applied as a coating to aluminum panels.

### Corrosion Inhibiting Formulations

In a first aspect, a corrosion inhibiting formulation is provided. The corrosion inhibiting formulation includes (a) at least one resin, (b) at least one Brønsted acid and (c) at least one thio-containing corrosion inhibitor. In some respects, the at least one resin includes a thermoplastic resin, for example, polyvinyl polymer, polyurethane polymer, acrylate polymer, a styrene polymer, or a combination thereof. In these respects, the thermoplastic resin is selected from a group consisting of a polyvinyl polymer, a polyurethane polymer, an acrylate polymer and a styrene polymer, or a combination thereof. In some respects, the thermoplastic resin includes a polyvinyl polymer. In some respects, the polyvinyl polymer is selected from a group consisting of a polyvinyl acetal polymer, a polyvinyl butyral polymer and a polyvinyl formal polymer, or a combination thereof. In some respects, the polyvinyl polymer includes a polyvinyl butyral polymer.

In some respects, the at least one Brønsted acid is selected from a group consisting of H₃PO₄; H₂SO₄; HX, wherein X is Cl, Br or F; and HNO₃; or a combination thereof. In some respects, the at least one Brønsted acid comprises H₃PO₄.

In some respects, the at least one thio-containing corrosion inhibitor includes a thiadiazole compound. In some of these respects, the thiadiazole compound is selected from a group consisting of structures (I)-(V):

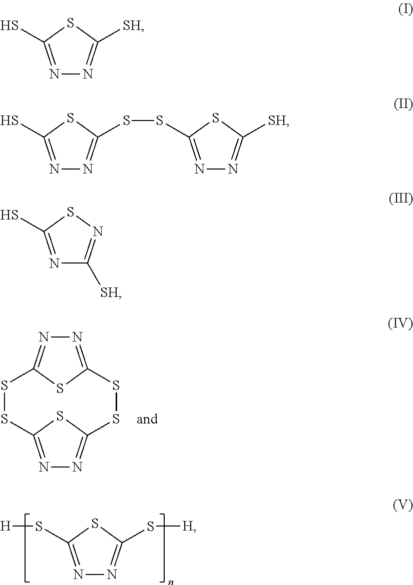

or a combination thereof, wherein n of structure (V) is equal to or greater than 2.

In some of these respects, the thiadiazole compound is selected from a group consisting of:

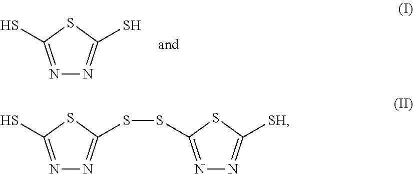 [SMILES: Sc1nnc(S)s1 ; "and" ; Sc1nnc(SSc2nnc(S)s2)s1]

or a combination thereof.

In some of these respects, the thiadiazole compound is selected from a group consisting of:

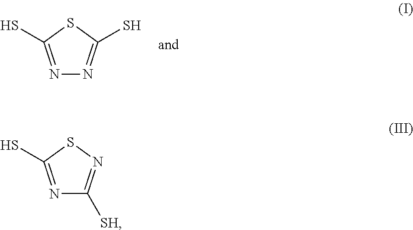 [SMILES: Sc1nnc(S)s1 ; "and" ; Sc1nsc(S)n1]

or a combination thereof.

In some respects, the at least one thio-containing corrosion inhibitor comprises a metal-containing thiadiazole compound. In some of these respects, the metal-containing thiadiazole compound is selected from the group consisting of: 2,5-dimercapto-1,3,4-thiadiazole, dipotassium salt; poly[Zn:2,5-dimercapto-1,3,4-thiadiazole (1:1)]; [Al:2,5-dimercapto-1,3,4-thiadiazole (1:3)]; [Al:2,5-dimercapto-1,3,4-thiadiazole (3:1)]; poly[Zn:(bis-(2,5-dithio-1,3,4-thiadiazole) (1:1)]; poly[Fe:2,5-dimercapto-1,3,4-thiadiazole) (1:1)]; poly[Al:2,5-dimercapto-1,3,4-thiadiazole (1:1)]; and poly[Cu:2,5-dimercapto-1,3,4-thiadiazole (1:1)]; or a combination thereof. In some of these respects, the metal-containing thiadiazole compound is poly[Zn:2,5-dimercapto-1,3,4-thiadiazole (1:1)].

In some respects, the corrosion inhibiting formulations include specific proportions (for example, % (wt/wt)) of the at least one resin, the at least one Brønsted acid and the at least one thio-containing corrosion inhibitor. In one regard, the at least one resin is present in an amount ranging from about 8% (wt/wt) to about 99% (wt/wt), including subranges from about 10% (wt/wt) to about 99% (wt/wt), from about 15% (wt/wt) to about 99% (wt/wt), from about 25% (wt/wt) to about 99% (wt/wt), and from about 50% (wt/wt) to about 99% (wt/wt). The at least one Brønsted acid is present in an amount ranging from about 1% (wt/wt) to about 10% (wt/wt), including subranges from about 2% (wt/wt) to about 10% (wt/wt), from about 3% (wt/wt) to about 10% (wt/wt), from about 5% (wt/wt) to about 10% (wt/wt), from about 6% (wt/wt) to about 10% (wt/wt), and from about 8% (wt/wt) to about 10% (wt/wt). The at least one thio-containing corrosion inhibitor is present in an amount ranging from about 0.01% (wt/wt) to about 30% (wt/wt), including subranges from about 0.01% (wt/wt) to about 30% (wt/wt), from about 0.05% (wt/wt) to about 30% (wt/wt), from about 0.10% (wt/wt) to about 30% (wt/wt), from about 0.20% (wt/wt) to about 30% (wt/wt), from about 0.40% (wt/wt) to about 30% (wt/wt), from about 1% (wt/wt) to about 30% (wt/wt), from about 2% (wt/wt) to about 30% (wt/wt), from about 5% (wt/wt) to about 30% (wt/wt), from about 10% (wt/wt) to about 30% (wt/wt), from about 15% (wt/wt) to about 30% (wt/wt), from about 20% (wt/wt) to about 30% (wt/wt), and from about 25% (wt/wt) to about 30% (wt/wt). Within these ranges and subranges, specific amounts of the components are contemplated. For example, the at least one resin can be present in an amount of about 8.2% (wt/wt), about 10% (wt/wt), about 15% (wt/wt), about 20% (wt/wt), about 25% (wt/wt), about 30% (wt/wt), about 40% (wt/wt), about 50% (wt/wt), about 60% (wt/wt), about 70% (wt/wt), about 80% (wt/wt), 90% (wt/wt), about 95% (wt/wt), and about 99% (wt/wt). The at least one Brønsted acid can present in an amount of about 1% (wt/wt), about 2% (wt/wt), about 3.2% (wt/wt), about 4% (wt/wt), about 5% (wt/wt), about 6% (wt/wt), about 8% (wt/wt), and about 10% (wt/wt). The at least one thio-containing corrosion inhibitor is present in an amount of about 0.01% (wt/wt), about 0.02% (wt/wt), about 0.05% (wt/wt), about 0.1% (wt/wt), about 0.2% (wt/wt), about 0.4% (wt/wt), about 1% (wt/wt), about 2% (wt/wt), about 5% (wt/wt), about 10% (wt/wt), about 15% (wt/wt), about 20% (wt/wt), about 25% (wt/wt) and about 30% (wt/wt).

These and other components can be included in the corrosion inhibiting formulations provided that the cumulative amounts of all components do not exceed 100% (wt/wt). Examples of other components include solvents and fluids for suspending or dissolving the aforementioned the at least one resin, the at least one Brønsted acid and the at least one thio-containing corrosion inhibitor. Exemplary solvents and fluids include water, ethanol, acetone, 2-butoxyethanol, n-butyl acetate, n-butyl alcohol, n-butyl proprionate, cyclohexanone, diacetone alcohol, dimethyl esters, N,N-dimethylacetamide, N,N-dimethylformamide, dimethylsufoxide, ethyl acetate, ethylene dichloride, isophorone, isopropyl acetate, isopropyl alcohol, methyl acetate, methyl amyl ketone, methyl ethyl ketone, methyl isoamyl ketone, methyl isobutyl ketone, methyl propyl ketone, methyl propyl ketone, methylene chloride, N-methyl 2-pyrrolidone, propyl propionate, propylene dichloride, tetrahydrofuran, 1,1,1-trichloroethane, among others, including combinations thereof.

Within these ranges, specific types of the components are contemplated. In this regard, for example, the at least one resin includes polyvinylbutaryl; and the at least one Brønsted acid includes H₃PO₄. Where specific formulations contemplate these particular resin and Brønsted acid components, the specific formulations include the at least one thio-containing corrosion inhibitor is selected from a group consisting of:

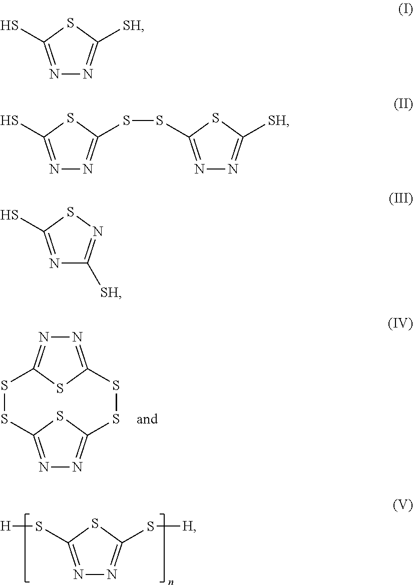

or a combination thereof, wherein n of structure (V) is equal to or greater than 2.

In some aspects, a corrosion inhibiting formulation includes at least one resin being polyvinylbutaryl, at least one Brønsted acid being H₃PO₄ and at least one thio-containing corrosion inhibitor being selected from one of compounds (I)-(V). Exemplary corrosion inhibiting formulations meeting these component criteria include at least one of formulations (1)-(140) shown in Table 1.

TABLE 1
Exemplary corrosion inhibiting formulations

| | Polyvinylbutyral | Thio-containing corrosion inhibitor | H₃PO₄ |
|---|---|---|---|
| Formulation | (% wt/wt) | (% wt/wt) | (% wt/wt) |
| 1 | 74.99 | 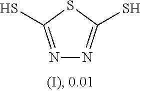 | 10.0 |
| 2 | 79.99 | 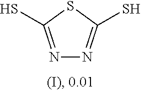 | 6.0 |
| 3 | 89.99 | 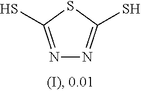 | 4.0 |
| 4 | 98.99 | 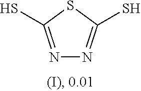 | 1.0 |
| 5 | 74.9 | 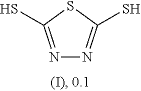 | 10.0 |
| 6 | 79.9 | 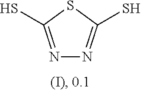 | 6.0 |
| 7 | 89.9 | 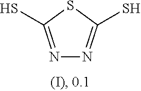 | 4.0 |
| 8 | 98.9 | 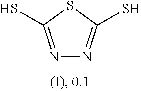 | 1.0 |
| 9 | 74.6 | 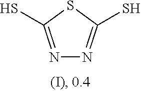 | 10.0 |
| 10 | 50.0 | 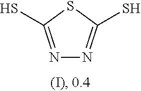 | 6.0 |
| 11 | 8.2 | 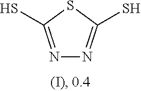 | 3.2 |
| 12 | 20.6 | 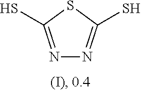 | 1.0 |
| 13 | 70.0 | 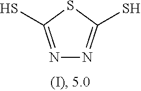 | 10.0 |
| 14 | 74.4 | 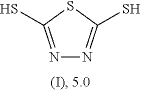 | 6.0 |
| 15 | 85.0 | 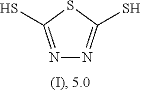 | 4.0 |
| 16 | 94.0 | 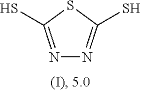 | 1.0 |
| 17 | 65.0 | 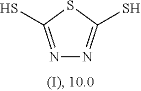 | 10.0 |
| 18 | 75.0 | 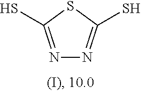 | 6.0 |
| 19 | 80.0 | 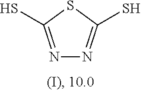 | 4.0 |
| 20 | 89.0 | 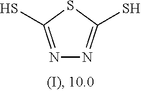 | 1.0 |
| 21 | 55.0 | 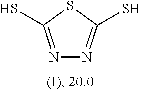 | 10.0 |
| 22 | 65.0 | 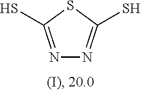 | 6.0 |
| 23 | 70.0 | 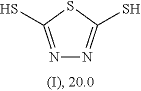 | 4.0 |
| 24 | 79.0 | 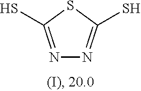 | 1.0 |
| 25 | 50.0 | 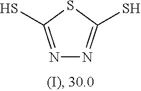 | 10.0 |
| 26 | 55.0 | 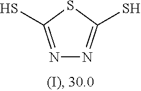 | 6.0 |
| 27 | 60.0 | 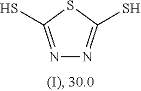 | 4.0 |
| 28 | 69.0 | 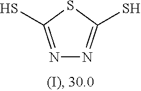 | 1.0 |
| 29 | 74.99 | 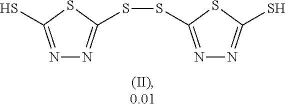 [SMILES: Sc1nnc(SSc2nnc(S)s2)s1] | 10.0 |
| 30 | 84.99 | 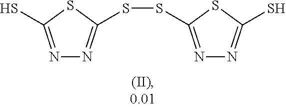 [SMILES: Sc1nnc(SSc2nnc(S)s2)s1] | 6.0 |
| 31 | 89.99 | 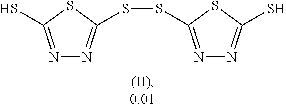 [SMILES: Sc1nnc(SSc2nnc(S)s2)s1] | 4.0 |
| 32 | 98.99 | 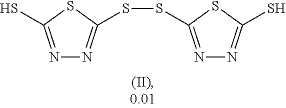 [SMILES: Sc1nnc(SSc2nnc(S)s2)s1] | 1.0 |
| 33 | 74.9 | 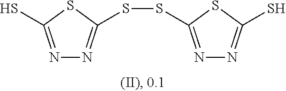 [SMILES: Sc1nnc(SSc2nnc(S)s2)s1] | 10.0 |
| 34 | 84.9 | 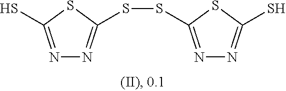 [SMILES: Sc1nnc(SSc2nnc(S)s2)s1] | 6.0 |
| 35 | 89.9 | 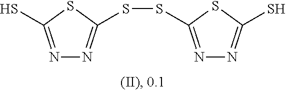 [SMILES: Sc1nnc(SSc2nnc(S)s2)s1] | 4.0 |
| 36 | 98.9 | 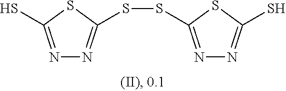 [SMILES: Sc1nnc(SSc2nnc(S)s2)s1] | 1.0 |
| 37 | 74.6 | 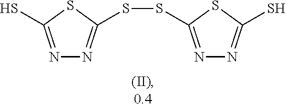 [SMILES: Sc1nnc(SSc2nnc(S)s2)s1] | 10.0 |
| 38 | 50.0 | 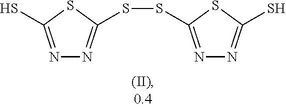 [SMILES: Sc1nnc(SSc2nnc(S)s2)s1] | 6.0 |
| 39 | 8.2 | 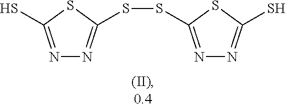 [SMILES: Sc1nnc(SSc2nnc(S)s2)s1] | 3.2 |
| 40 | 20.6 | 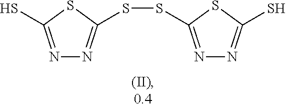 [SMILES: Sc1nnc(SSc2nnc(S)s2)s1] | 1.0 |
| 41 | 70.0 | 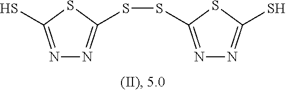 [SMILES: Sc1nnc(SSc2nnc(S)s2)s1] | 10.0 |
| 42 | 74.4 | 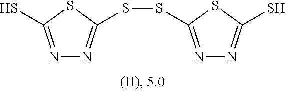 [SMILES: Sc1nnc(SSc2nnc(S)s2)s1] | 6.0 |
| 43 | 85.0 | 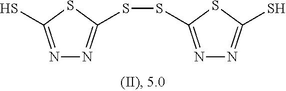 [SMILES: Sc1nnc(SSc2nnc(S)s2)s1] | 4.0 |
| 44 | 94.0 | 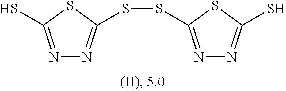 [SMILES: Sc1nnc(SSc2nnc(S)s2)s1] | 1.0 |
| 45 | 65.0 | 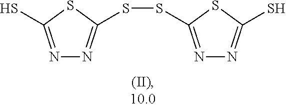 [SMILES: Sc1nnc(SSc2nnc(S)s2)s1] | 10.0 |
| 46 | 70.0 | 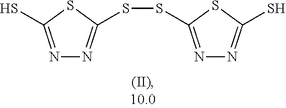 [SMILES: Sc1nnc(SSc2nnc(S)s2)s1] | 6.0 |
| 47 | 80.0 | 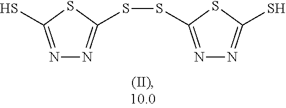 [SMILES: Sc1nnc(SSc2nnc(S)s2)s1] | 4.0 |
| 48 | 89.0 | 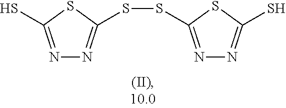 [SMILES: Sc1nnc(SSc2nnc(S)s2)s1] | 1.0 |
| 49 | 55.0 | 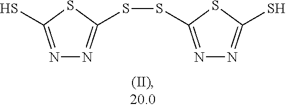 [SMILES: Sc1nnc(SSc2nnc(S)s2)s1] | 10.0 |
| 50 | 60.0 | 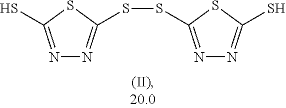 [SMILES: Sc1nnc(SSc2nnc(S)s2)s1] | 6.0 |
| 51 | 70.0 | 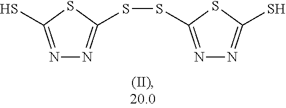 [SMILES: Sc1nnc(SSc2nnc(S)s2)s1] | 4.0 |
| 52 | 79.0 | 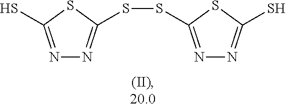 [SMILES: Sc1nnc(SSc2nnc(S)s2)s1] | 1.0 |
| 53 | 50.0 | 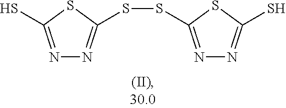 [SMILES: Sc1nnc(SSc2nnc(S)s2)s1] | 10.0 |
| 54 | 55.0 | 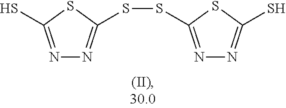 [SMILES: Sc1nnc(SSc2nnc(S)s2)s1] | 6.0 |
| 55 | 60.0 | 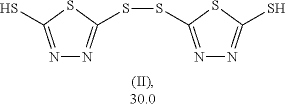 [SMILES: Sc1nnc(SSc2nnc(S)s2)s1] | 4.0 |
| 56 | 69.0 | 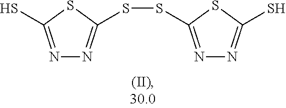 [SMILES: Sc1nnc(SSc2nnc(S)s2)s1] | 1.0 |
| 57 | 74.99 | 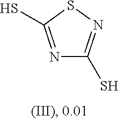 | 10.0 |
| 58 | 84.99 | 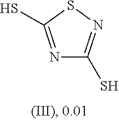 | 6.0 |
| 59 | 89.99 | 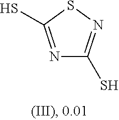 | 4.0 |
| 60 | 98.99 | 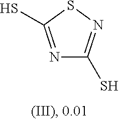 | 1.0 |
| 61 | 74.9 | 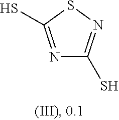 | 10.0 |
| 62 | 84.9 | 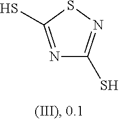 | 6.0 |
| 63 | 89.9 | 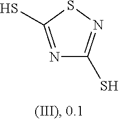 | 4.0 |
| 64 | 98.9 | 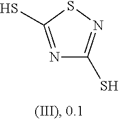 | 1.0 |
| 65 | 74.6 | 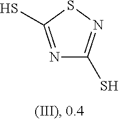 | 10.0 |
| 66 | 50.0 | 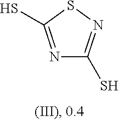 | 6.0 |
| 67 | 8.2 | 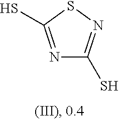 | 3.2 |
| 68 | 20.6 | 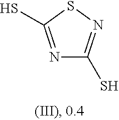 | 1.0 |
| 69 | 70.0 | 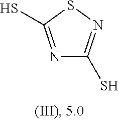 | 10.0 |
| 70 | 74.4 | 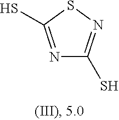 | 6.0 |
| 71 | 85.0 | 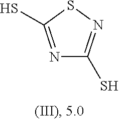 | 4.0 |
| 72 | 94.0 | 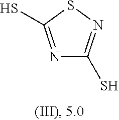 | 1.0 |
| 73 | 65.0 | 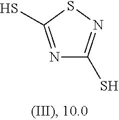 | 10.0 |
| 74 | 70.0 | 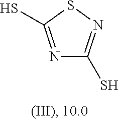 | 6.0 |
| 75 | 80.0 | 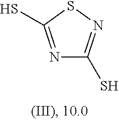 | 4.0 |
| 76 | 89.0 | 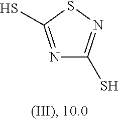 | 1.0 |
| 77 | 55.0 | 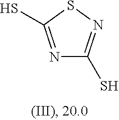 | 10.0 |
| 78 | 60.0 | 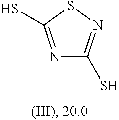 | 6.0 |
| 79 | 70.0 | 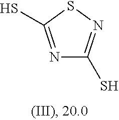 | 4.0 |
| 80 | 79.0 | 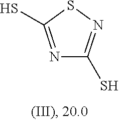 | 1.0 |
| 81 | 50.0 | 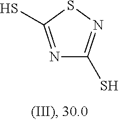 | 10.0 |
| 82 | 55.0 | 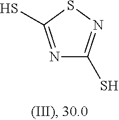 | 6.0 |
| 83 | 60.0 | 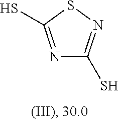 | 4.0 |
| 84 | 69.0 | 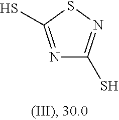 | 1.0 |
| 85 | 74.99 | 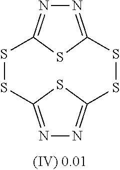 [SMILES: N1=C2SSc3nnc(s3)SSC(=N1)S2] | 10.0 |
| 86 | 84.99 | 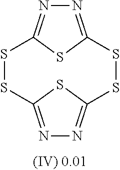 [SMILES: N1=C2SSc3nnc(s3)SSC(=N1)S2] | 6.0 |
| 87 | 89.99 | 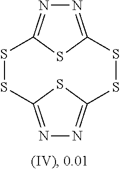 [SMILES: N1=C2SSc3nnc(s3)SSC(=N1)S2] | 4.0 |
| 88 | 98.99 | 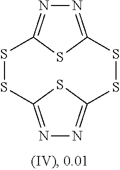 [SMILES: N1=C2SSc3nnc(s3)SSC(=N1)S2] | 1.0 |
| 89 | 74.9 | 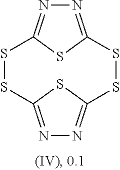 [SMILES: N1=C2SSc3nnc(s3)SSC(=N1)S2] | 10.0 |
| 90 | 84.9 | 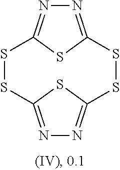 [SMILES: N1=C2SSc3nnc(s3)SSC(=N1)S2] | 6.0 |
| 91 | 89.9 | 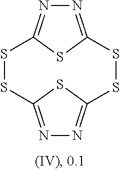 [SMILES: N1=C2SSc3nnc(s3)SSC(=N1)S2] | 4.0 |
| 92 | 98.9 | 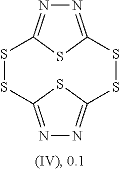 [SMILES: N1=C2SSc3nnc(s3)SSC(=N1)S2] | 1.0 |
| 93 | 74.6 | 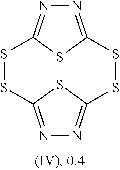 [SMILES: N1=C2SSc3nnc(s3)SSC(=N1)S2] | 10.0 |
| 94 | 50.0 | 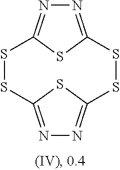 [SMILES: N1=C2SSc3nnc(s3)SSC(=N1)S2] | 6.0 |
| 95 | 8.2 | 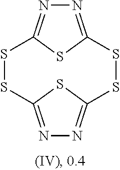 [SMILES: N1=C2SSc3nnc(s3)SSC(=N1)S2] | 3.2 |
| 96 | 20.6 | 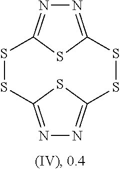 [SMILES: N1=C2SSc3nnc(s3)SSC(=N1)S2] | 1.0 |
| 97 | 70.0 | 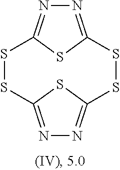 [SMILES: N1=C2SSc3nnc(s3)SSC(=N1)S2] | 10.0 |
| 98 | 74.4 | 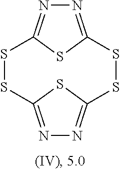 [SMILES: N1=C2SSc3nnc(s3)SSC(=N1)S2] | 6.0 |
| 99 | 85.0 | 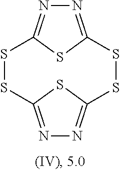 [SMILES: N1=C2SSc3nnc(s3)SSC(=N1)S2] | 4.0 |
| 100 | 94.0 | 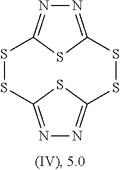 [SMILES: N1=C2SSc3nnc(s3)SSC(=N1)S2] | 1.0 |
| 101 | 65.0 | 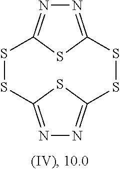 [SMILES: N1=C2SSc3nnc(s3)SSC(=N1)S2] | 10.0 |
| 102 | 70.0 | 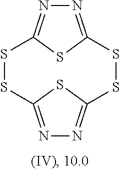 [SMILES: N1=C2SSc3nnc(s3)SSC(=N1)S2] | 6.0 |
| 103 | 80.0 | 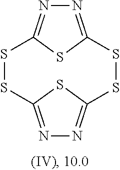 [SMILES: N1=C2SSc3nnc(s3)SSC(=N1)S2] | 4.0 |
| 104 | 89.0 | 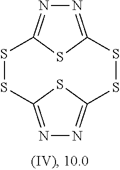 [SMILES: N1=C2SSc3nnc(s3)SSC(=N1)S2] | 1.0 |
| 105 | 55.0 | 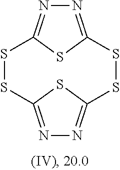 [SMILES: N1=C2SSc3nnc(s3)SSC(=N1)S2] | 10.0 |
| 106 | 60.0 | 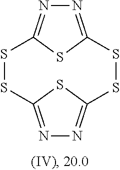 [SMILES: N1=C2SSc3nnc(s3)SSC(=N1)S2] | 6.0 |
| 107 | 70.0 | 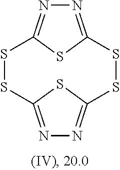 [SMILES: N1=C2SSc3nnc(s3)SSC(=N1)S2] | 4.0 |
| 108 | 79.0 | 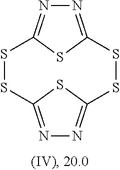 [SMILES: N1=C2SSc3nnc(s3)SSC(=N1)S2] | 1.0 |
| 109 | 50.0 | 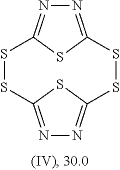 [SMILES: N1=C2SSc3nnc(s3)SSC(=N1)S2] | 10.0 |
| 110 | 55.0 | 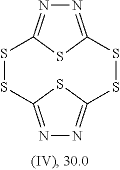 [SMILES: N1=C2SSc3nnc(s3)SSC(=N1)S2] | 6.0 |
| 111 | 60.0 | 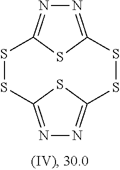 [SMILES: N1=C2SSc3nnc(s3)SSC(=N1)S2] | 4.0 |
| 112 | 69.0 | 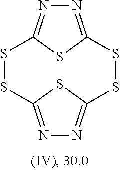 [SMILES: N1=C2SSc3nnc(s3)SSC(=N1)S2] | 1.0 |
| 113 | 74.99 | 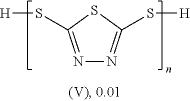 | 10.0 |
| 114 | 84.99 | 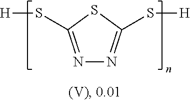 | 6.0 |
| 115 | 89.99 | 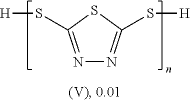 | 4.0 |
| 116 | 98.99 | 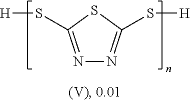 | 1.0 |
| 117 | 74.9 | 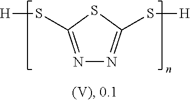 | 10.0 |
| 118 | 84.9 | 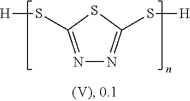 | 6.0 |
| 119 | 89.9 | 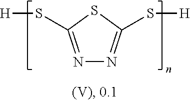 | 4.0 |
| 120 | 98.9 | 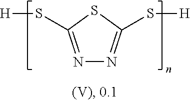 | 1.0 |
| 121 | 74.6 | 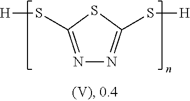 | 10.0 |
| 122 | 50.0 | 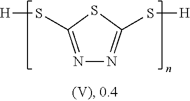 | 6.0 |
| 123 | 8.2 | 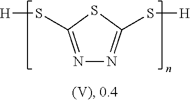 | 3.2 |
| 124 | 20.6 | 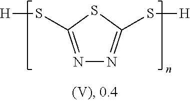 | 1.0 |
| 125 | 70.0 | 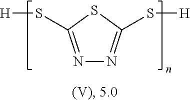 | 10.0 |
| 126 | 74.4 | 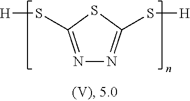 | 6.0 |
| 127 | 85.0 | 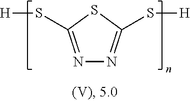 | 4.0 |
| 128 | 94.0 | 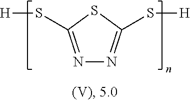 | 1.0 |
| 129 | 65.0 | 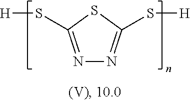 | 10.0 |
| 130 | 70.0 | 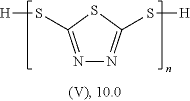 | 6.0 |
| 131 | 80.0 | 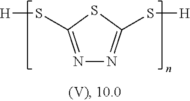 | 4.0 |
| 132 | 89.0 | 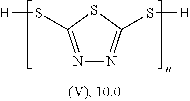 | 1.0 |
| 133 | 55.0 | 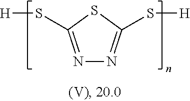 | 10.0 |
| 134 | 60.0 | 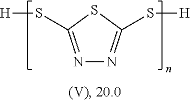 | 6.0 |
| 135 | 70.0 | 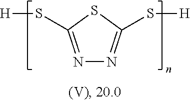 | 4.0 |
| 136 | 79.0 | 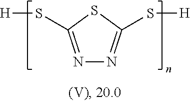 | 1.0 |
| 137 | 50.0 | 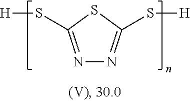 | 10.0 |
| 138 | 55.0 | 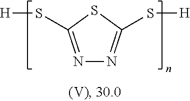 | 6.0 |
| 139 | 60.0 | 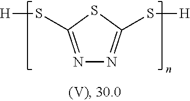 | 4.0 |
| 140 | 69.0 | 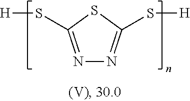 | 1.0 |

### Substrate Coatings

In a second aspect, a substrate coating including a corrosion inhibiting formulation is provided. The corrosion inhibiting formulation includes: (a) at least one resin, (b) at least one Brønsted acid and (c) at least one thio-containing corrosion inhibitor. In some respects, the at least one resin includes a thermoplastic resin. In these respects, thermoplastic resin is selected from a group consisting of a polyvinyl polymer, a polyurethane polymer, an acrylate polymer and a styrene polymer, or a combination thereof. In some of these respects, the thermoplastic resin includes a polyvinyl polymer. In some of these respects, the polyvinyl polymer is selected from a group consisting of a polyvinyl acetal polymer, a polyvinyl butyral polymer and a polyvinyl formal polymer, or a combination thereof. In some respects, the polyvinyl polymer includes a polyvinyl butyral polymer.

In some respects, the at least one Brønsted acid is selected from a group consisting of H₃PO₄; H₂SO₄; HX, wherein X is Cl, Br or F; and HNO₃; or a combination thereof. In some of these respects, the at least one Brønsted acid includes H₃PO₄.

In some respects, the at least one thio-containing corrosion inhibitor includes a thiadiazole compound. In some of these respects, the thiadiazole compound is selected from a group consisting of structures (I)-(V):

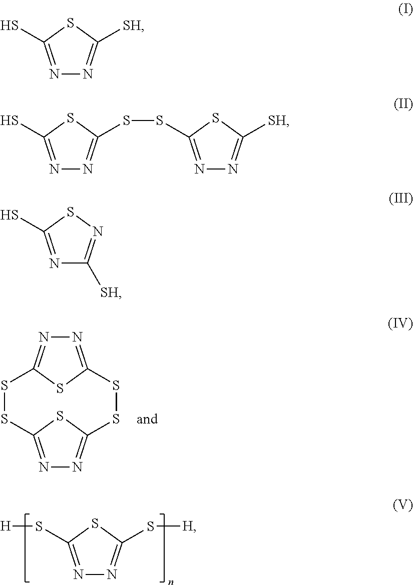

or a combination thereof, wherein n of structure (V) is equal to or greater than 2.

In some of these respects, the thiadiazole compound is selected from a group consisting of:

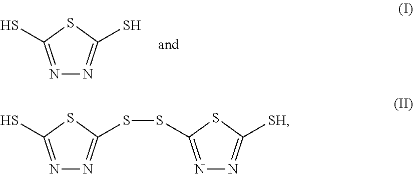 [SMILES: Sc1nnc(S)s1 ; "and" ; Sc1nnc(SSc2nnc(S)s2)s1]

or a combination thereof.

In some of these respects, the thiadiazole compound is selected from a group consisting of:

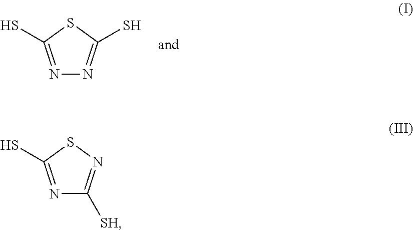 [SMILES: Sc1nnc(S)s1 ; "and" ; Sc1nsc(S)n1]

or a combination thereof.

In some respects, the at least one thio-containing corrosion inhibitor comprises a metal-containing thiadiazole compound. In some of these respects, the metal-containing thiadiazole compound is selected from the group consisting of: 2,5-dimercapto-1,3,4-thiadiazole, dipotassium salt; poly[Zn:2,5-dimercapto-1,3,4-thiadiazole (1:1)]; [Al:2,5-dimercapto-1,3,4-thiadiazole (1:3)]; [Al:2,5-dimercapto-1,3,4-thiadiazole (3:1)]; poly[Zn:(bis-(2,5-dithio-1,3,4-thiadiazole) (1:1)]; poly[Fe:2,5-dimercapto-1,3,4-thiadiazole) (1:1)]; poly[Al:2,5-dimercapto-1,3,4-thiadiazole (1:1)]; and poly[Cu:2,5-dimercapto-1,3,4-thiadiazole (1:1)]; or a combination thereof. In some of these respects, the metal-containing thiadiazole compound is poly[Zn:2,5-dimercapto-1,3,4-thiadiazole (1:1)].

In some respects, the substrate coating includes a corrosion inhibiting formulation having specific proportions (for example, wt/wt) of the at least one resin, the at least one Brønsted acid and the at least one thio-containing corrosion inhibitor. In one regard, the at least one resin is present in an amount ranging from about 8% (wt/wt) to about 99% (wt/wt), including subranges from about 10% (wt/wt) to about 99% (wt/wt), from about 15% (wt/wt) to about 99% (wt/wt), from about 25% (wt/wt) to about 99% (wt/wt), and from about 50% (wt/wt) to about 99% (wt/wt). The at least one Brønsted acid is present in an amount ranging from about 1% (wt/wt) to about 10% (wt/wt), including the subranges from about 2% (wt/wt) to about 10% (wt/wt), from about 3% (wt/wt) to about 10% (wt/wt), from about 5% (wt/wt) to about 10% (wt/wt), from about 6% (wt/wt) to about 10% (wt/wt), and from about 8% (wt/wt) to about 10% (wt/wt). The at least one thio-containing corrosion inhibitor is present in an amount ranging from about 0.01% (wt/wt) to about 30% (wt/wt), including subranges from about 0.01% (wt/wt) to about 30% (wt/wt), from about 0.05% (wt/wt) to about 30% (wt/wt), from about 0.10% (wt/wt) to about 30% (wt/wt), from about 0.20% (wt/wt) to about 30% (wt/wt), from about 0.40% (wt/wt) to about 30% (wt/wt), from about 1% (wt/wt) to about 30% (wt/wt), from about 2% (wt/wt) to about 30% (wt/wt), from about 5% (wt/wt) to about 30% (wt/wt), from about 10% (wt/wt) to about 30% (wt/wt), from about 15% (wt/wt) to about 30% (wt/wt), from about 20% (wt/wt) to about 30% (wt/wt), and from about 25% (wt/wt) to about 30% (wt/wt). Within these ranges and subranges, specific amounts of the components are contemplated. For example, the at least one resin can be present in an amount of about 8.2% (wt/wt), about 10% (wt/wt), about 15% (wt/wt), about 20% (wt/wt), about 25% (wt/wt), about 30% (wt/wt), about 40% (wt/wt), about 50% (wt/wt), about 60% (wt/wt), about 70% (wt/wt), about 80% (wt/wt), 90% (wt/wt), about 95% (wt/wt), and about 99% (wt/wt). The at least one Brønsted acid can present in an amount of about 1% (wt/wt), about 2% (wt/wt), about 3.2% (wt/wt), about 4% (wt/wt), about 5% (wt/wt), about 6% (wt/wt), about 8% (wt/wt), and about 10% (wt/wt). The at least one thio-containing corrosion inhibitor is present in an amount of about 0.01% (wt/wt), about 0.02% (wt/wt), about 0.05% (wt/wt), about 0.1% (wt/wt), about 0.2% (wt/wt), about 0.4% (wt/wt), about 1% (wt/wt), about 2% (wt/wt), about 5% (wt/wt), about 10% (wt/wt), about 15% (wt/wt), about 20% (wt/wt), about 25% (wt/wt) and about 30% (wt/wt).

These and other components can be included in the substrate coating having the corrosion inhibiting formulations provided that the cumulative amounts of all components do not exceed 100% (wt/wt). Examples of other components include solvents and fluids for suspending or dissolving the aforementioned the at least one resin, the at least one Brønsted acid and the at least one thio-containing corrosion inhibitor. Exemplary solvents and fluids include water, ethanol, acetone, 2-butoxyethanol, n-butyl acetate, n-butyl alcohol, n-butyl proprionate, cyclohexanone, diacetone alcohol, dimethyl esters, N,N-dimethylacetamide, N,N-dimethylformamide, dimethylsufoxide, ethyl acetate, ethylene dichloride, isophorone, isopropyl acetate, isopropyl alcohol, methyl acetate, methyl amyl ketone, methyl ethyl ketone, methyl isoamyl ketone, methyl isobutyl ketone, methyl propyl ketone, methyl propyl ketone, methylene chloride, N-methyl 2-pyrrolidone, propyl propionate, propylene dichloride, tetrahydrofuran, 1,1,1-trichloroethane, among others, including combinations thereof.

Other components can be included in the substrate coating, such as, for example, dyes, colorants, pigments and the like.

Within these ranges, specific types of the components are contemplated. In this regard, the substrate coating includes a corrosion inhibiting formulation having at least one resin being polyvinylbutaryl and the at least one Brønsted acid being H₃PO₄. Where substrate coatings include specific formulations that contemplate these particular resin and Brønsted acid components, the specific formulations include the at least one thio-containing corrosion inhibitor selected from a group consisting of:

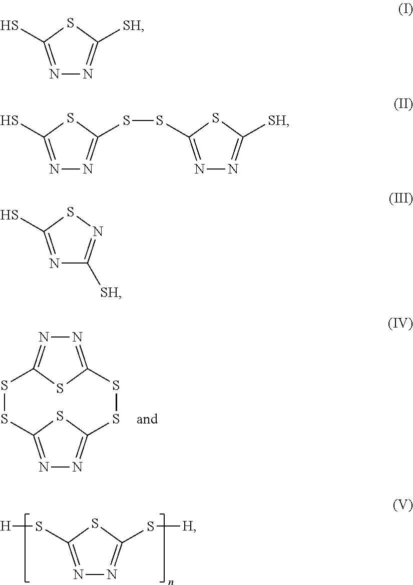

or a combination thereof, wherein n of structure (V) is equal to or greater than 2.

In some respects, a substrate coating having a corrosion inhibiting formulation includes at least one resin being polyvinylbutaryl, at least one Brønsted acid being H₃PO₄, and the at least one thio-containing corrosion inhibitor being selected from a group consisting of compounds (I)-(V). Exemplary substrate coatings meeting these component criteria include a corrosion inhibiting formulation selected from at least one of formulations (1)-(140) shown in Table 1 supra.

In a third aspect, a method of applying a corrosion inhibiting formulation on a substrate is disclosed. The method includes two steps. The first step includes coating a corrosion inhibiting formulation on the substrate. The corrosion inhibiting formulation includes (a) at least one resin, (b) at least one Brønsted acid and (c) at least one thio-containing corrosion inhibitor. The second step includes curing the coating. In some respects, the step of disposing a coating onto the substrate includes at least one of dipping, brushing, flow-coating, screen-printing, slot-die coating, gravure coating, powder coating, spraying, and spin-coating the coating onto the substrate. In some respects, the step of curing the coating includes subjecting the coating to a temperature ranging from about 65° F. to about 160° F.

### Synthesis of Electroactive Cathodic-Thio Systems

The thio-containing corrosion inhibitors of the present disclosure are electroactive cathodic-thio compounds. Certain thio-containing corrosion inhibitors include commercially available thiadiazole compounds selected from a group consisting of structures (I)-(III) and (VI), as shown in Table 2.

TABLE 2
Exemplary commercially available thiadiazole compounds as corrosion
inhibitors.

| Compound | Structure | IUPAC Name [CAS No.] |
|---|---|---|
| I | 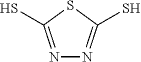 | 1,3,4-Thiadiazole-2,5-dithiol [1072-71-5] |
| II | 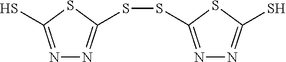 [SMILES: Sc1nnc(SSc2nnc(S)s2)s1] | 5,5′-Dithiobis(1,3,4-Thiadiazole- 2(3H)-thione) [72676-55-2] |
| III | 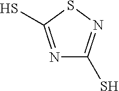 | 1,2,4-Thiadiazole-3,5-dithiol [20939-17-7] |
| VI | 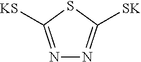 | 1,3,4-Thiadiazole-2,5-dithiol, dipotassium salt [4628-94-8] |

Vanlube 829 represents a commercial lubricant additive of compound (II) (Vanderbilt Chemicals, LLC (Norwalk, Conn. (US)).

The following thio-containing corrosion inhibitors include known thiadiazole compounds (IV) and (V) that can be synthesized from oxidation of compound (I) under appropriate conditions, as shown in Table 3.

TABLE 3
Exemplary thiadiazole compounds as corrosion inhibitors.

| Com- | | |
|---|---|---|
| pound | Structure and IUPAC Name | Citation for Synthesis |
| IV | 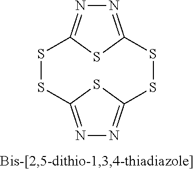 [SMILES: N1=C2SSc3nnc(s3)SSC(=N1)S2] | Hugo et al. US4599425A (1986) (see also Example 1) |
| V | 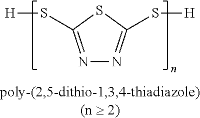 | E. Ziegele, J. Prakt. Chem. 60: 40 (1899) (see also Example 2) |

The following thio-containing corrosion inhibitors include novel metal thiadiazole compounds (VII)-(XIII) that can be synthesized according to the particular examples disclosed herein, as shown in Table 4.

TABLE 4
Exemplary metal thiadiazoles as thio-containing corrosion inhibitors

| Com- | | Synthesis |
|---|---|---|
| pound | Predicted Structure^{a} and IUPAC Name | Example |
| VII | 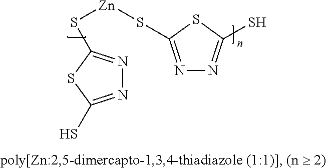 | Example 3 |
| VIII | 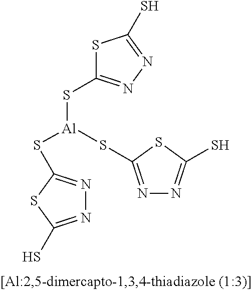 | Example 4 |
| IX | 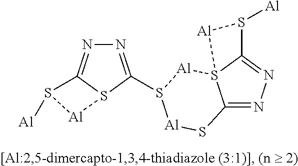 | Example 5 |
| X | 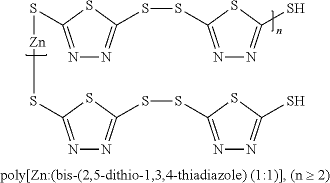 | Example 6 |
| XI | 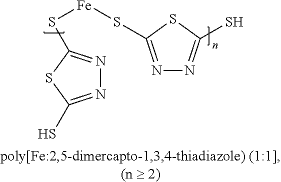 | Example 7 |
| XII | 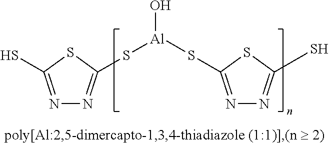 | Example 8 |
| XIII | 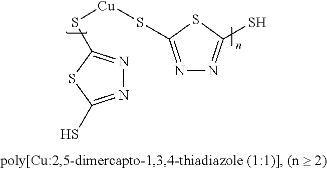 | Example 9 |

^{a}Predicted structure is based upon considerations of molar ratios of synthetic reagents, not upon analytical characterization of the resultant product of synthesis.

The exemplary thio-containing corrosion inhibitors were characterized for electroactive cathodic-thio compound activity. The corrosion of metal is attributed to the following oxidation reaction (Scheme I):

M→M⁺+e⁻ (Scheme I)

An electroactive cathodic-thio compound inhibits corrosion by carrying out reduction of oxygen according to the following oxygen reduction reactions (Scheme II):

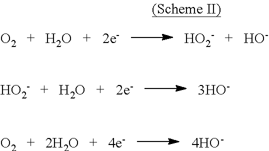

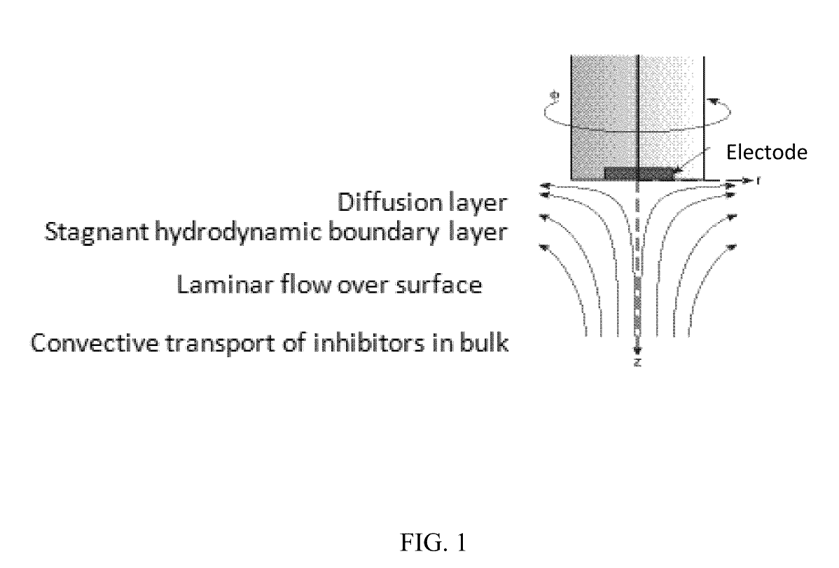

Linear sweep voltammetry (LSV) and chronoamperometry were used to evaluate the performance of the thio-containing corrosion inhibitors as electroactive cathodic-thio compounds. The LSV experiments were performed with a rotating disc electrode (RDE). The rotating disc electrode technique provides certain benefits in measurement sensitivity because the technique indicates current at steady state with a kinetic flow over the electrode rather than a static measurement in solution (FIG. 1).

Inhibitor performance was measured based on the ability of the compound to prevent the oxygen reduction reaction in electrolyte using a rotating disc electrode. If current values were closer to zero then the inhibitor was considered to be appropriate because the oxygen reduction reaction, which is an indication of corrosion, was sequestered or stopped. Solutions of known concentration (e.g., containing 10 ppm inhibitor) were used to compared inhibitors. Inhibitor efficiency (I_{E}), is calculated using Equation 1 (I_{E} corrects for contributions not attributable to the inhibitor (e.g., electrolyte)).

Inhibitor Efficiency=(i_{inhibitor}−i_{blank})/i_{blank} (Equation 1)

Performance of different inhibitors (10 ppm solutions) was evaluated by measuring current value (A) at −800 mV and determining inhibitor efficiency, the results of which are shown in Table 5.

TABLE 5
Performance of exemplary thio-containing inhibitors

| | | | Current (A) | Current (A) | |
|---|---|---|---|---|---|
| Compound^{a} | Compound^{b} | n | @ 800 mV | S.D. | I_{E} |
| 1,2,4 DMcT | III | 10 | −1.53 × 10⁻⁴ | −9.14 × 10⁻⁵ | 0.70 |
| ZnDMcT | VII | 4 | −2.13 × 10⁻⁴ | −5.08 × 10⁻⁵ | 0.58 |
| 1:3AlDMcT | VIII | 4 | −2.25 × 10⁻⁴ | −9.41 × 10⁻⁵ | 0.55 |
| 3:1 AlDMcT | IX | 4 | −2.59 × 10⁻⁴ | −1.05 × 10⁻⁵ | 0.49 |
| Vanlube 829 | II | 3 | −2.68 × 10⁻⁴ | −1.62 × 10⁻⁵ | 0.47 |
| 1:3AlDMcT | VIII | 3 | −2.83 × 10⁻⁴ | −7.95 × 10⁻⁵ | 0.44 |
| (acid) | | | | | |
| BDTD | IV | 3 | −3.00 × 10⁻⁴ | −4.01 × 10⁻⁵ | 0.40 |
| polyZn(Bis- | X | 2 | −3.12 × 10⁻⁴ | −1.32 × 10⁻⁵ | 0.38 |
| DMcT) | | | | | |
| Fe(II)DMcT | XI | 3 | −3.23 × 10⁻⁴ | −8.65 × 10⁻⁶ | 0.36 |
| PDTD | V | 1 | −3.11 × 10⁻⁴ | NA | 0.34 |
| 1:1 AlDMcT | XII | 3 | −3.51 × 10⁻⁴ | −1.96 × 10⁻⁵ | 0.30 |
| Cu(II)DMcT | XIII | 3 | −4.01 × 10⁻⁴ | −2.36 × 10⁻⁵ | 0.20 |
| None | | 8 | −5.03 × 10⁻⁴ | −1.19 × 10⁻⁴ | 0.00 |
| (Blank) | | | | | |

^{a}Compound abbreviations are as follows: 1,2,4 DMcT = 1,2,4-Thiadiazole-3,5-dithiol (III); ZnDMcT = poly[Zn: 2,5-dimercapto-1,3,4-thiadiazole (1:1)], (n ≧ 2); 1:3AlDMcT = [Al: 2,5-dimercapto-1,3,4-thiadiazole (1:3)]; 3:1 AlDMcT = Al: 2,5-dimercapto-1,3,4-thiadiazole (3:1)]; Vanlube 829 = 5,5′-Dithiobis(1,3,4-Thiadiazole-2(3H)-thione); 1:3AlDMcT (acid) = [Al: 2,5-dimercapto-1,3,4-thiadiazole (1:3)] (acid); BDTD = Bis-[2,5-dithio-1,3,4-thiadiazole]; polyZn(Bis-DMcT) = poly[Zn: bis-(2,5-dithio-1,3,4-thiadiazole)(1:1)], (n ≧ 2); Fe(II)DMcT = poly[Fe: 2,5-dimercapto-1,3,4-thiadiazole) (1:1)], (n ≧ 2); PDTD = poly-(2,5-dithio-1,3,4- thiadiazole); 1:1 AlDMcT = poly[Al:2,5-dimercapto-1,3,4-thiadiazole (1:1)], (n ≧ 2); and Cu(II)DMcT = poly[Cu: 2,5-dimercapto-1,3,4-thiadiazole (1:1)], (n ≧ 2).
^{b}Compounds designated as described in Tables 2-4.

The solubility of a corrosion inhibitor is loosely correlated to its performance in an aqueous solution (not shown). A correlation between solubility in an electrolyte and measured inhibitor performance indicates that solubility affects performance. For this reason, the performance of a corrosion inhibitor is preferably evaluated in a resin system rather than in an electrolyte.

### Preparation of Corrosion Inhibiting Formulations and Coatings

Incorporating corrosion inhibitors into a resin allows performance evaluation under normal use conditions as compared to in an aqueous or organic solvent. The 2,3-dimercapto 1,3,4-thiadiazole (DMcT) based inhibitor compounds are known to be reactive with epoxy resins typically used for aerospace primers. DMcT is known to protonate the amine curative and to break the epoxy ring to form a strong C—S bond.

A polyvinyl butyral (PVB) resin system was selected as an exemplary resin system for incorporating the inhibitors because it is relatively non-reactive, has good adhesion, and is not soluble in water to allow for electrochemical testing and performance evaluation. PVB resins are typically used as clear “wash primers” on metallic surfaces prior to top coating. Polyvinyl butyral is a thermoplastic resin that is cross-linked with heat and a trace metallic acid. In this particular respect, phosphoric acid was used as the catalyst. PVB (XIV) is made from a reaction between polyvinyl alcohol (PVOH) and butyraldehyde with acid as a catalyst.

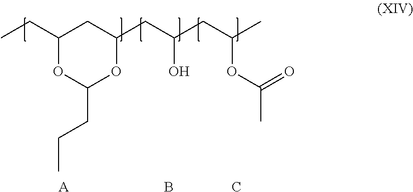

Bracketed moieties A, B and C are distributed randomly along the PVB polymer molecule.

Organic inhibitors generally require a higher loading because they have a higher pigment absorption value compared to conventional corrosion inhibiting pigments such as strontium chromate and zinc chromate. The exemplary DMcT and Vanlube 829 oil absorption values were within the same relative range of strontium chromate, allowing for very minor modifications to the MIL C 8514 formulation that contained strontium chromate.

Open circuit potential (OCP) measures the combined potential of two half cell reactions at equilibrium (Jones, 1996; Scheme III).

M→M²⁺+2e⁻

2H⁺+2e⁻→H₂ (Scheme III)

OCP measurements were collected on panels with PVB resin with 0%, 0.5%, and 5% (wt/wt) DMcT loadings using a clamp cell filled with 5% (wt/wt) NaCl electrolyte buffered with Phosphate-Buffered Saline (PBS) and a platinum reference electrode. The metal panel was the working electrode in these measurements. OCP was measured over time until the potential value came to steady state.

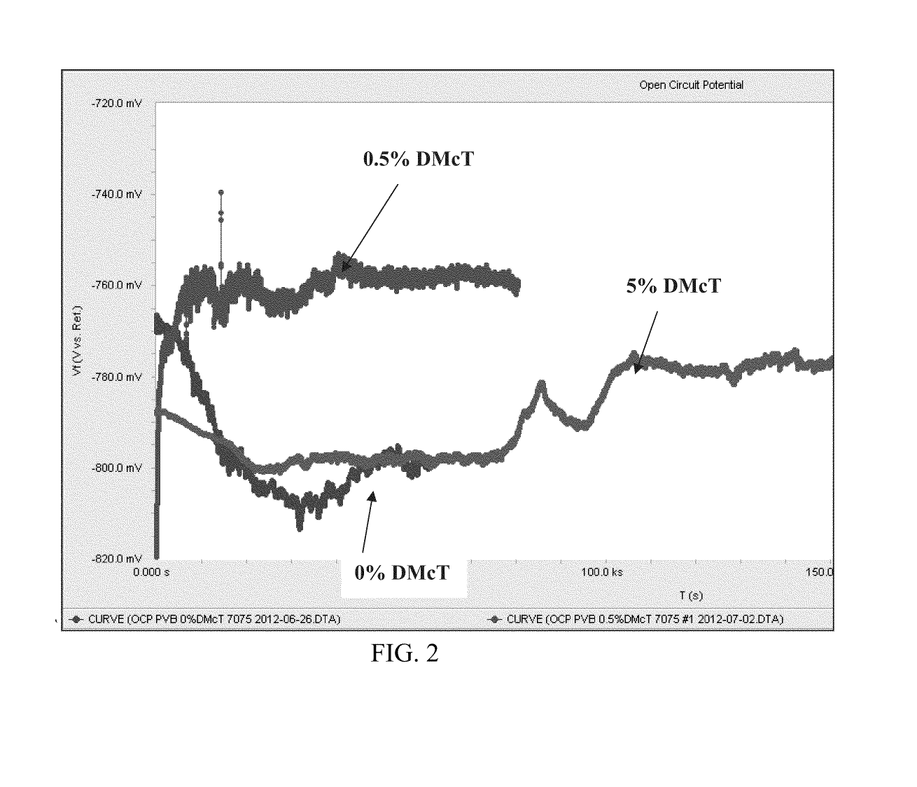

A correlation between the time to reach steady state and inhibitor loading was observed. The 5% DMcT panel took the longest time, approximately 100 ks (28 h), to come to steady state while the panels with no or 0.5% inhibitor took the shorter, 25 ks and 50 ks (7 h and 14 h) time to reach steady state (FIG. 2). This correlation provides a robust measure of the performance of corrosion inhibitors on panels that is more sensitive than LSV experiments with solutions containing corrosion inhibitor.

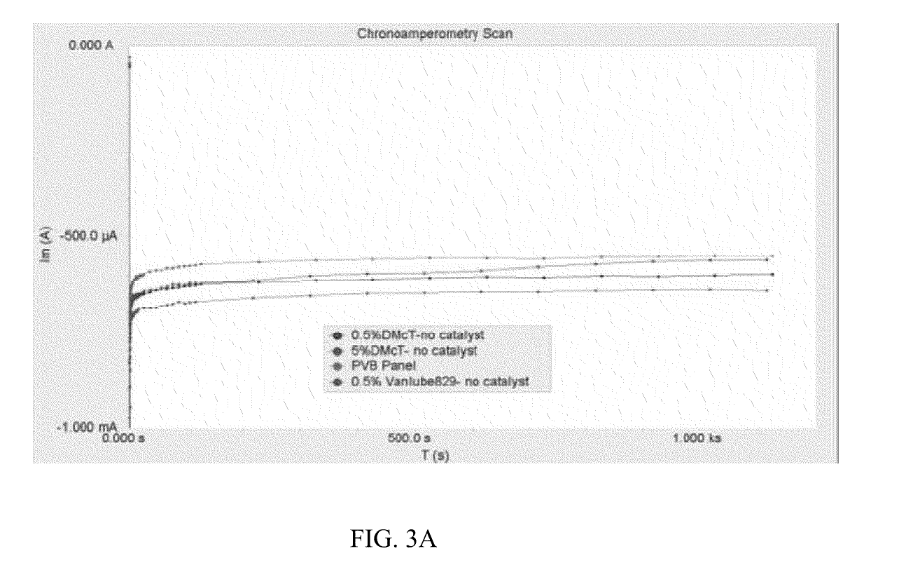

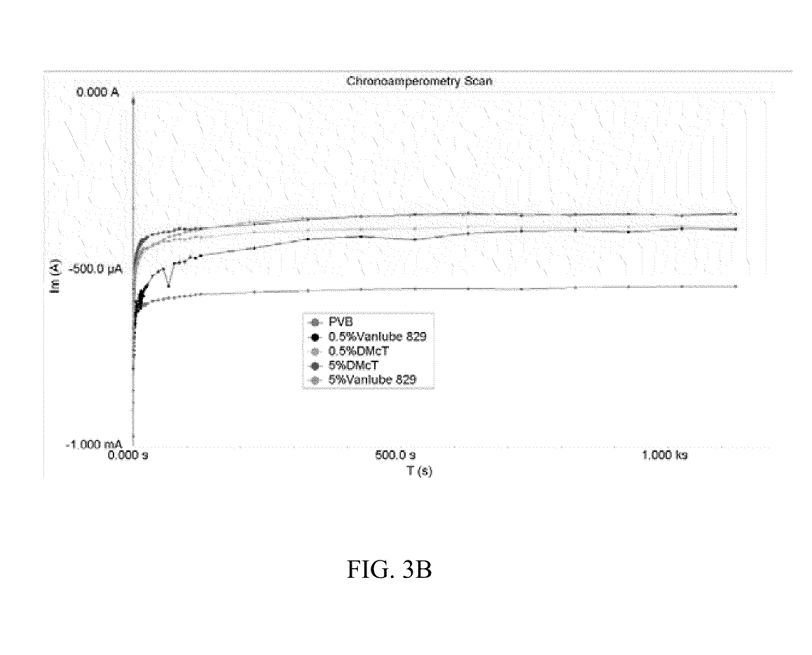

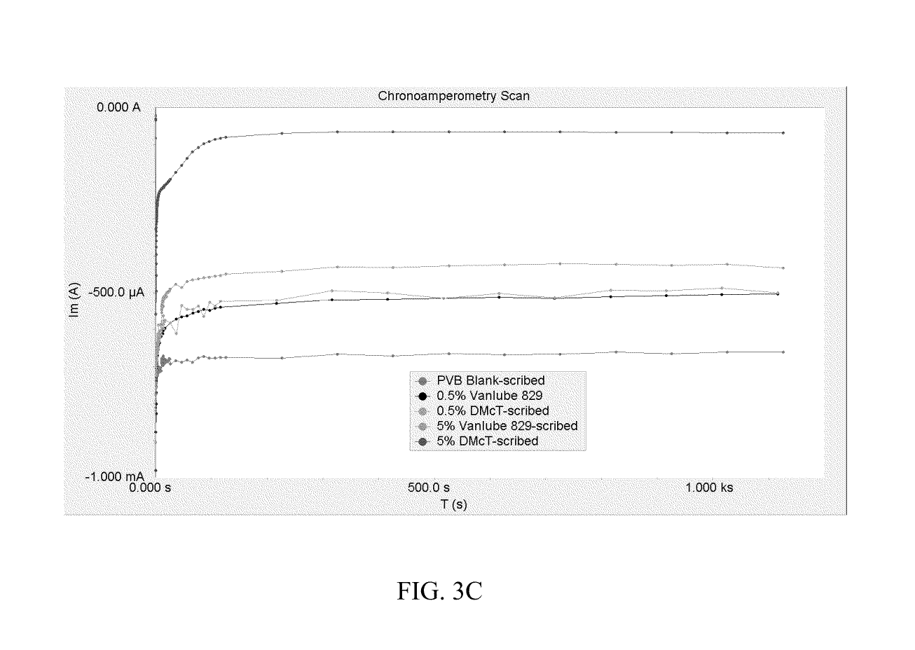

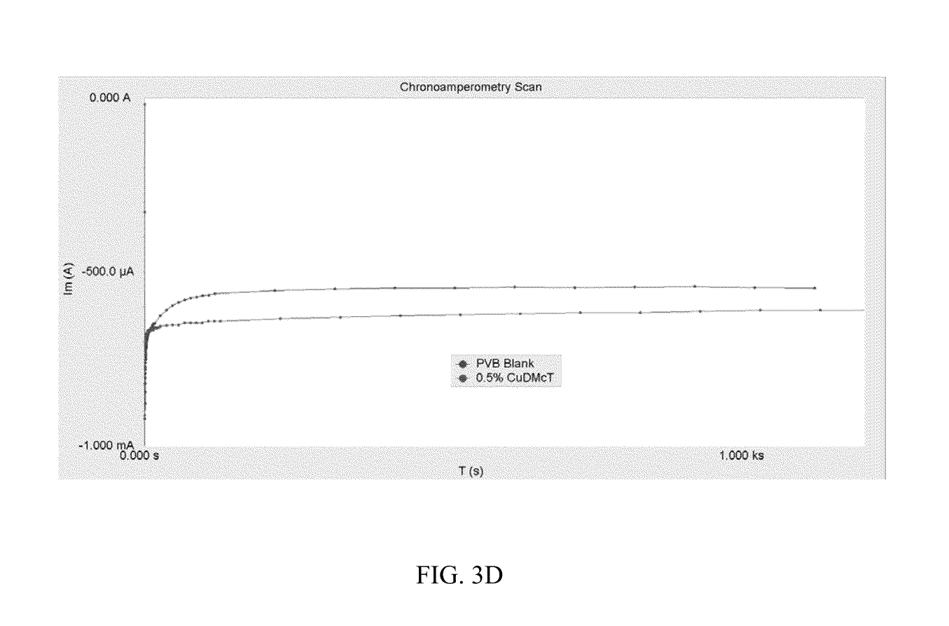

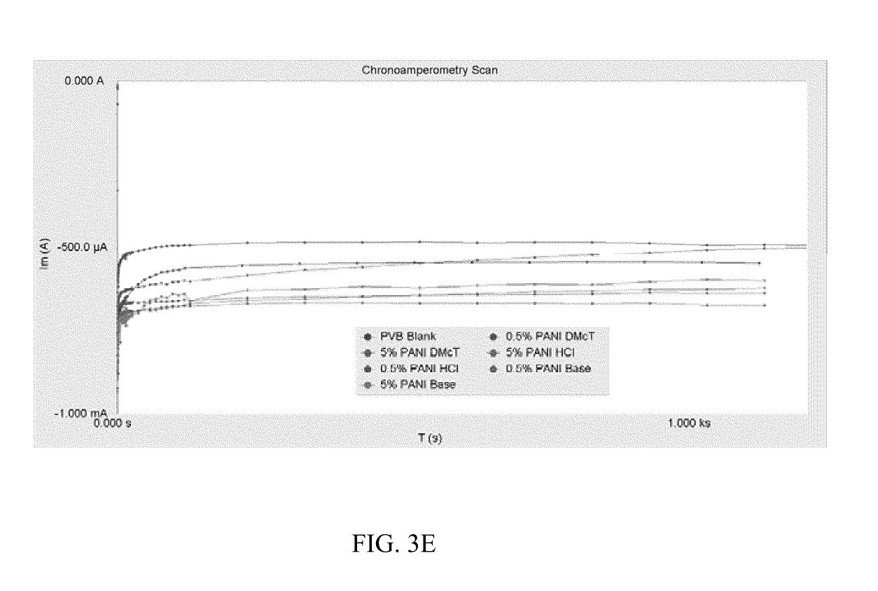

Chronoamperometry was performed on panel substrates having exemplary corrosion inhibiting coatings applied to their surfaces (FIG. 3A-E). Coatings that included an acid catalyst performed better than those that lacked an acid catalyst, as compared to resin coating lacking a thio-containing corrosion inhibitor (compare FIGS. 3A and 3B). Scribing panel substrates following coating enhanced the observed differences in chronoamperometry performance of panel substrates containing a thio-containing inhibiting coating compared with a coating lacking a thio-containing corrosion inhibitor (FIG. 3C). Compound (XIII) (Cu(II)DMcT) performed better than control solution in the LSV experiments (Table 5, supra). Yet this compound was an ineffective corrosion inhibitor in a corrosion inhibiting formulation coated on a panel substrate, as compared to a formulation lacking an corrosion inhibitor (FIG. 3D). PANI coating formulations differed in their performance as a corrosion inhibiting formulation when compared to a formulation lacking an corrosion inhibitor (FIG. 3E). Using the results from chronoamperometry (FIG. 3A-E), Equation 2 was used to calculate each inhibitor's efficiency (I.E.):

$$Inhibitor Efficiency ( I . E . ) = 1 - \frac{{i}_{I}}{{i}_{0}} \qquad ( Equation 2 )$$

where i_{I}=current at equilibrium of coating with inhibitor (μA), and i₀=current at equilibrium of coating with no inhibitor (μA). Table 6 summarizes data for exemplary corrosion inhibiting formulations and coatings.

TABLE 6
Inhibitor Efficiencies for exemplary corrosion
inhibiting formulations and coatings.

| | | |
|---|---|---|
| Coating¹ | iₗ (mA) | I.E. (%)² |

Experiment 1:

| | | |
|---|---|---|
| PVB (no inhibitor) | −546.8 | 0.0 |
| 0.5% Vanlube 829-no catalyst | −641.3 | −17.3 |
| 0.5% DMcT-no catalyst | −595.0 | −8.8 |
| 5% DMcT-no catalyst | −559.4 | −2.3 |

Experiment 2:

| | | |
|---|---|---|
| PVB (no inhibitor) | −550.1 | 0.0 |
| 0.5% Vanlube 829 | −385.6 | 29.9 |
| 0.5% DMcT | −383.1 | 30.4 |
| 5% DMcT | −343.4 | 37.6 |
| 5% Vanlube 829 | −340.5 | 38.1 |

Experiment 3:

| | | |
|---|---|---|
| PVB (no inhibitor)-Scribed | −661.4 | 0.0 |
| 0.5% Vanlube 829-Scribed | −500 | 24.4 |
| 0.5% DMcT-Scribed | −500 | 24.4 |
| 5% Vanlube 829-Scribed | −433.1 | 34.5 |
| 5% DMcT-Scribed | −67.7 | 89.8 |

Experiment 4:

| | | |
|---|---|---|
| PVB (no inhibitor) | −547.4 | 0.0 |
| 0.5% PANI DMcT | −448.9 | 10.7 |
| 5% PANI DMcT | −505.6 | 7.6 |
| 5% PANI HCl | −622.6 | −13.7 |
| 0.5% PANI HCl | −639.9 | −16.9 |
| 5% PANI Base | −597.5 | −9.2 |
| 0.5% PANI Base | −678.3 | −23.9 |

Experiment 5:

| | | |
|---|---|---|
| 0.5% Cu(DMcT)₂ | −612.1 | −11.8 |

¹Inhibitor Efficiency (I.E.) was calculated according to Eqn. 2.

Positive values for Inhibitor Efficiency presented in Table 6 reflects an effective corrosion inhibiting formulation as a coating when compared to a control resin (e.g., PVB). Negative values for Inhibitor Efficiency presented in Table 6 reflects an ineffective corrosion inhibiting formulation as a coating when compared to a control resin (e.g., PVB lacking an inhibitor).

### Examples

### Example 1

### Synthesis of Bis-[2,5-dithio-1,3,4-thiadiazole] (IV)

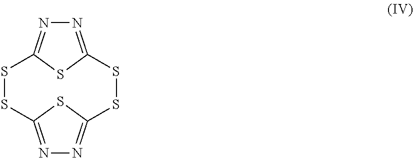 [SMILES: N1=C2SSc3nnc(s3)SSC(=N1)S2]

Fifteen grams of DMcT (0.1 mole) in the form of a powder was suspended in 200 ml of water at 0° C. While vigorously stirring the suspension, 30% hydrogen peroxide solution (14 g (0.1 mole)) was added drop wise (using the peristaltic pump) at a slow rate such that the reaction temperature did not exceed 50° C. One hour after the addition of the peroxide, the BDTD product was filtered off, washed three times with deionized water, and dried at 50° C. for 12 hr.

### Example 2

### Synthesis of poly-(2,5-dithio-1,3,4-thiadiazole) (V)

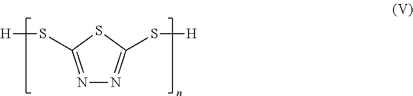

Twenty-two grams of dipotassium 1,3,4-thiadiazole-2,5-dithiolate (KDMcT) (0.1 mole) was dissolved in 200 ml of water at 20° C. Ammonium persulfate (25.1 g) was dissolved in 120 ml water. While vigorously stirring the KDMcT solution, the persulfate solution was added drop wise with a peristaltic pump over a period of 45 min. The solution was stirred an additional hour (solids formed during this period). The resulting PDTD product was washed 4× with 200 ml water. The solids were transferred to a Waring® blender, dispersed in 200 ml water and acidified with 0.1 M HCl to bring the pH to 2.0. The product was washed again with water (6×250 ml) and dried in a vacuum desiccator.

### Example 3

### Synthesis of poly[Zn:2,5-dimercapto-1,3,4-thiadiazole (1:1)], (n≧2) (VII)

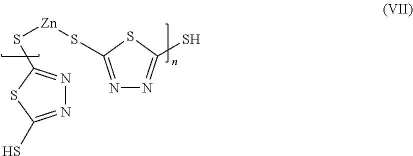

Fifteen grams of DMcT (0.1 mole) was dispersed in 250 ml of water at 20° C. One hundred grams of 8% sodium hydroxide was slowly added with stirring. A clear yellow solution formed. Zinc chloride (13.6 grams (0.1 mole)) was dissolved in 100 ml water and slowly added to the yellow DMcT solution. The resulting solution was stirred one hour at room temperature. A white precipitate formed. The precipitate was washed with distilled water and vacuum dried for 16 hours at 80° C.

### Example 4

### Synthesis of [Al:2,5-dimercapto-1,3,4-thiadiazole (1:3)] (VIII)

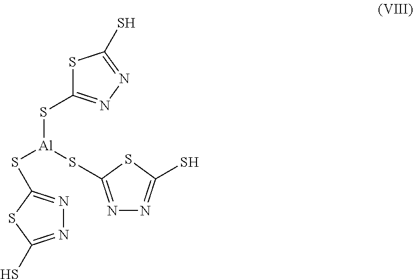

For [Al:2,5-dimercapto-1,3,4-thiadiazole (1:3)], 75 g of DMcT (0.5 mole) was dissolved in 1 liter of 1.0 N NaOH (1 mole). All of the DMcT dissolved to yield a clear amber-yellow solution. Aluminum nitrate nonahydrate (62.5 g (0.167 mole)) was slowly added to the DMcT solution with stirring at which time a light yellow colored precipitate immediately began to form. The resulting mixture, which has a DMcT to aluminum molar ratio of 3:1, was slowly stirred for 4 hours. The pH of the slurry, measured using a glass electrode, was determined to be 5.44. Using vacuum filtration, the slurry was filtered through Whatman® 1001 125 qualitative filter paper and washed 3 times with 250 ml portions of MilliQ® water. After air drying, 18.4 grams of yellow powder was recovered (Crop 1). The colorless filtrate had a pH of 5.49 (volume=1.25 liters). 50 ml of 3.8 M H₂SO₄ was added to the filtrate to bring the pH down to 1.26. During the addition of the acid, a cloudy precipitate formed. A slight “sulfur” odor was detected. This precipitate was vacuum filtered and washed 4 times with 100 ml MilliQ® water and air dried. 13.2 g of light yellow product was recovered (Crop 2).

The [Al:2,5-dimercapto-1,3,4-thiadiazole (1:3)] (acid) form was prepared in an identical manner except that the initial step of 75 g of DMcT (0.5 mole) being dissolved in 1 liter of 1.0 N NaOH (1 mole) was omitted. Instead, 75 g of DMcT (0.5 mole) was dissolved in 1 liter of water and reacted with 62.5 g (0.167 mole) of aluminum nitrate nonahydrate as described above.

### Example 5

### Synthesis of [Al:2,5-dimercapto-1,3,4-thiadiazole (3:1)] (IX)

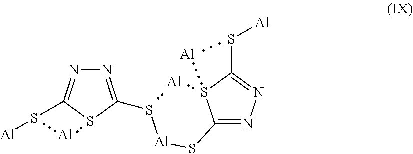

Fifteen grams (0.1 mole) of DMcT was dispersed in 250 ml of water at 20° C. One hundred grams of 8% sodium hydroxide was slowly added with stirring. A clear yellow solution formed. Aluminum nitrate nonahydrate (112.54 grams (0.3 mole)) was dissolved in 100 ml water and slowly added to the yellow DMcT solution. The resulting solution was stirred for one hour at room temperature. A solid precipitate formed that was washed 3× with DI water.

### Example 6

### Synthesis of poly[Zn:(bis-(2,5-dithio-1,3,4-thiadiazole) (1:1)], (n≧2) (X)

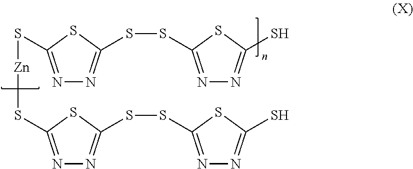

Vanlube 829 DMcT Dimer (Compound (II)) (59.6 g (0.2 mole)) was dispersed in 400 ml of 1.0M NaOH at ambient temperature with N₂ sparging. A cloudy yellow slurry formed. 27.2 grams (0.2 mole) of solid zinc chloride was dissolved in 200 ml of distilled water. The zinc chloride solution was slowly added to the cloudy yellow slurry. A pale yellow slurry immediately formed. The slurry was stirred overnight at room temperature with N₂ sparging. Using vacuum filtration, the slurry was filtered through a nylon filter membrane with 0.45 μm pores. The precipitate, Zn(Bis-DMcT), was washed 3× with 100 ml with distilled water and air dried before being placed in a vacuum desiccator overnight to complete drying.

### Example 7

### Synthesis of poly[Fe:2,5-dimercapto-1,3,4-thiadiazole) (1:1)], (n≧2) (XI)

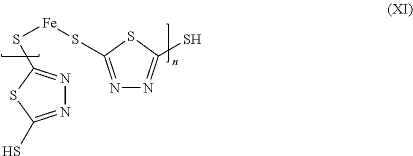

Fifteen grams (0.1 mole) of DMcT was dispersed in 250 ml of water at 20° C. One hundred grams of 8% sodium hydroxide was slowly added with stirring. A clear yellow solution formed. Twenty-seven grams (0.1 mole) of ferrous sulfate heptahydrate (FW=278.02) was dissolved in 100 ml water and slowly added to the yellow NaDMcT solution. The resulting solution was stirred for one hour at room temperature. A fine black precipitate formed. The precipitate was washed 3× with 100 ml of distilled water and vacuum dried at 80° C.

### Example 8

### Synthesis of poly[Al:2,5-dimercapto-1,3,4-thiadiazole (1:1)], (n≧2) (XII)

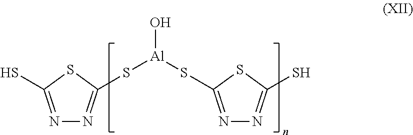

Fifteen grams (0.1 mole) of DMcT was dispersed in 250 ml of water at 20° C. One hundred grams of 8% sodium hydroxide was slowly added with stirring. A clear yellow solution formed. Aluminum nitrate nonahydrate (37.5 g (0.1 mole)) was dissolved in 100 ml water and slowly added to the yellow DMcT solution. The resulting solution was stirred for one hour at room temperature. A solid precipitate formed that was washed 3× with DI water and air dried to yield a powder.

### Example 9

### Synthesis of poly[Cu:2,5-dimercapto-1,3,4-thiadiazole (1:1)], (n≧2) (XIII)

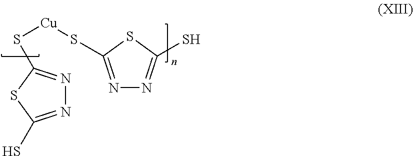

Fifteen grams (0.1 mole) of DMcT was dispersed in 250 ml of water at 20° C. One hundred grams of 8% sodium hydroxide was slowly added with stirring. A clear yellow solution formed. Copper (II) chloride dihydrate (17.0 g (0.1 mole)) was dissolved in 100 ml water and slowly added to the yellow DMcT solution. The resulting solution was stirred for one hour at room temperature. A white precipitate formed. The precipitate was washed with distilled water and vacuum dried for 16 hours at 80° C.

### Example 10

### Characterization of Thio-Containing Corrosion Inhibitors by Linear Sweep Voltammetry and Chronoamperometry

Electrolyte systems. Several electrolytes for studying the inhibitor in an aqueous solution were investigated and are summarized below in Table 7. The ions and ion concentrations of all of these solutions as well as the pH is shown. Dilute Harrison's solution is frequently used in electrochemical impedance spectroscopy (EIS) experiments. Properties of a “lap joint simulant solution” (LJSS) based on solution found in aircraft lap joints are also shown below (Ferrer, 2002). The standard 5% NaCl solution for neutral salt fog testing (ASTM B 117) is also presented.

TABLE 7
Exemplary electrolytes for electrochemical characterization of the thio-
containing inhibitors

| | Electrolyte System¹ | | | | | |
|---|---|---|---|---|---|---|
| | A | B | C | D | E | F |
| pH | 7.0 | 7.0 | 7.4 | 4.5 | 4.5 | 9.0 |
| Salt | % (wt/wt) [M (mol/L)] | | | | | |
| Total Ions | 6.0 [1.05] | 5.0 [0.90] | 1.0 [0.15] | 4.0 [0.36] | 0.4 [0.14] | 0.2 [0.03] |
| NaCl | 5.8 [1.04] | 5 [0.90] | 0.8 [0.14] | 0.5 [0.09] | 0.05 [0.07] | 0.1 [0.02] |
| (NH₄)₂SO₄ | N/A | N/A | N/A | 3.5 [0.28] | 0.35 [0.07] | N/A |
| KCl | 0.02 [0.0027] | N/A | 0.02 [0.0027] | N/A | N/A | N/A |
| Na₃PO₄ | 0.2 [0.01] | N/A | 0.2 [0.01] | N/A | N/A | N/A |
| NaNO₂ | N/A | N/A | N/A | N/A | N/A | 0.03 [0.004] |
| NaHCO₃ | N/A | N/A | N/A | N/A | N/A | 0.03 [0.004] |
| NaF | N/A | N/A | N/A | N/A | N/A | 0.01[0.002] |
| H₂O | 94.0 | 95.0 | 99.0 | 96.0 | 99.6 | 99.9 |

¹The electrolyte systems were as follows: A is 5% NaCl-Phosphate Buffered Saline (PBS); B is 5% NaCl-Neutral Salt Fog Chamber; C is PBS; D is Harrison's Solution (electrochemistry electrolyte); E is Dilute Harrison's Solution (EIS); and F is Lap Joint Simulation Solution (LJSS). “N/A” in the table reflects salt components not included in the designated electrolyte systems.

A 5% (wt/wt) sodium chloride solution (that is, electrolyte system A of Table 7) was selected to simulate a highly corrosive environment and potentially accelerate the corrosion. The electrolyte was buffered to eliminate changes in pH from effecting inhibitor performance measurements. A pH of 7 was selected because it was similar to seawater.

The 5% (wt/wt) (0.9 M) sodium chloride electrolyte solution was generated by adding reagent grade sodium chloride to <18 M·cm resistivity to deionized water (52.6 gm NaCl to 1 liter water). The solution was then buffered to neutral pH 7 with phosphate buffered saline tablets from Sigma Aldrich-(P4417-100TAB), 1 tablet per 200 ml of solution Inhibitors were dissolved in an 5% sodium chloride electrolyte buffered with phosphate buffered saline to maintain the pH at 7. Ten parts per million (10 ppm) solutions were generated by taking an aliquot of solutions with a higher known inhibitor concentration and diluting to make a 10 ppm solution. In most cases the higher concentration target was 50 ppm. The initial solutions were generated by adding 0.050 gm of inhibitor in a 5% NaCl buffered electrolyte in a one liter volumetric flask. Not all of the inhibitor dissolved, so the solution was filtered to calculate the solubility and the actual concentration. The solutions were stirred overnight with a stir bar and then filtered using a pre-weighed, 4.7 cm diameter, 1.0 micron pore size glass fiber filters (Whatman Grade GF/B 1821-047) and a Millipore glass filter funnel. The glass filter and clamp funnel was an improvement to previous filter methods that utilized a Buchner funnel and paper filters. After the filtrate was collected, the funnel and filter paper were rinsed thoroughly with deionized water to ensure that no electrolyte salts were trapped in the filter and that residual solids on the sides of the filter funnel were collected. The filter with solids was dried over night in an approximately 120° C. oven, allowed to come to room temperature in a desiccator, and weighed. The actual solution concentration was calculated based on the actual inhibitor dissolved. Concentration calculations also accounted for residual salts that are sometimes still present in the filter. These were measured by running a blank. An aliquot was taken of the 50 ppm solution and a final 10 ppm solution generated.

Linear Sweep Voltammetry and Chronoamperometry Experiments.

Linear sweep Voltammetry (LSV) of various inhibitors in solution was performed using an EG&G Princeton Applied Research Model 636 rotating disk electrode (RDE) rotator at 1000 rpm with a Series G-750 potentiostat, 750 microAmp version (PCI4G750-47062), with a platinum counter electrode and glass Calomel Ag/AgCl reference electrode (FIG. 6). Gamry Framework software was used. A copper disk (1 cm²) working electrode, polished between readings, was used. Purity of the 99%+ pure copper disk was verified to be 99, using a Baird DV4 Arc/Spark optical emission spectrometer.

To measure LSV, an electrical potential scan was performed between −0.3 and −1 volts with a scan rate of 10 mV/s. It was determined that the current values at the plateau at −0.800 V were an indication of inhibitor function. LSV values at steady state were measured by scanning repeatedly until the values stopped changing over time.

To measure chronoamperometry, potential was held at −0.800 V and the current measured over time until steady state values were obtained.

### Example 11

### Preparation of Corrosion Inhibitor Formulations and Coatings

Loading of the inhibitors in PVB resin was based on the critical pigment volume concentration determined using ASTM D 1483-95 Standard Test Method for Oil Absorption of Pigments by Gardner-Coleman Method. Pigment density and specific gravity values used for the calculations were found in literature (Koleske (1995); Vanderbilt Chemicals, LLC (2012)). DMcT and Vanlube 829 were tested as representative DMcT-based materials. Two concentrations of each thio-containing corrosion inhibitor in the coating, 5% and 0.5% were targeted based on the critical pigment volume concentration calculated from oil absorption values.

To prepare the exemplary corrosion inhibiting formulations of Table 1 and the coatings, the following materials were prepared: a resin, an acid catalyst, and a thio-containing corrosion inhibitor.

Resin.

An exemplary resin was prepared as follows. Fifty-nine grams (59 g) of Polyvinyl Butyral Butvar-76 was dissolved into 405 g of ethanol and 131 g of N-butanol using a high-shear, air-powered mixer with mixing overnight to provide a 10% resin (wt/wt) solution.

Acid Catalyst.

An exemplary acid catalyst solution was prepared as follows. Twenty grams (20 g) of phosphoric acid was combined with 17 g of deionized water and 73 g of ethanol to provide an 18.2% acid catalyst (wt/wt) solution.

To prepare the formulation or coating that includes 0.4% (wt/wt) thio-containing corrosion inhibitor, such as those depicted by formulations 11, 39, 67, 95 and 123 of Table 1, 61.7 g of resin (10% (wt/wt)) solution was added to a THINKY™ mixing cup fitted in high-shear THINKY™ mixer and 0.316 g of thio-containing inhibitor was added to the resin solution. Following mixing at 2000 RPM for 21 min, 13.1 g of acid catalyst (18.2% (wt/wt)) solution was added to the mixing cup and the resultant mixture was mixed for 1 min. The resultant corrosion inhibiting formulation includes 8.2% (wt/wt) resin, 3.2% (wt/wt) acid catalyst and 0.4% (wt/wt) thio-containing corrosion inhibitor.

### ADDITIONAL EXEMPLARY FORMULATIONS AND SUBSTRATE COATINGS

The remaining formulations of Table 1 that include thio-containing corrosion inhibitor formulations other than formulations 11, 39, 67, 95 and 123 are prepared as follows. Referring to compositions of Table 8, the indicated amount of resin is added to a THINKY™ mixing cup fitted in high-shear THINKY™ mixer and the indicated amount of thio-containing inhibitor is added to the resin. Following mixing at 2000 RPM for 21 min, the indicated amount of acid catalyst solution and a sufficient amount of solvent (anhydrous ethanol) to provide a final weight of 100 gm mixture are added to the mixing cup, and the resultant 100 gm mixture is mixed for 1 min. Each designated composition of Table 8 provides the requisite components specified for each corresponding formulation of Table 1, other than formulations 11, 39, 67, 95 and 123 described supra.

TABLE 8
Exemplary compositions and substrate coatings

| | PVB^{a} | Thio-containing corrosion inhibitor | H₃PO₄ | Solvent^{b} |
|---|---|---|---|---|
| Composition | (g) | (g) | (g) | (g) |
| 1 | 74.99 | 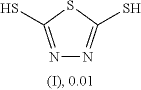 | 10.0 | 15.0 |
| 2 | 79.99 | 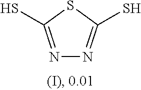 | 6.0 | 14.0 |
| 3 | 89.99 | 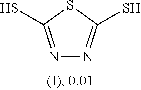 | 4.0 | 6.0 |
| 4 | 98.99 | 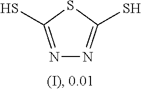 | 1.0 | N/A^{c} |
| 5 | 74.9 | 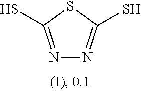 | 10.0 | 15.0 |
| 6 | 79.9 | 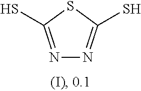 | 6.0 | 14.0 |
| 7 | 89.9 | 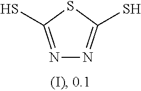 | 4.0 | 6.0 |
| 8 | 98.9 | 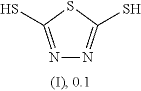 | 1.0 | N/A^{c} |
| 9 | 74.6 | 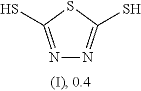 | 10.0 | 15.0 |
| 10 | 50.0 | 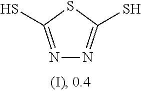 | 6.0 | 43.6 |
| 12 | 20.6 | 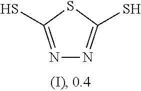 | 1.0 | 78.0 |
| 13 | 70.0 | 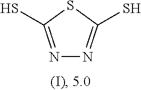 | 10.0 | 15.0 |
| 14 | 74.4 | 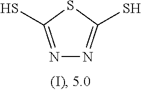 | 6.0 | 14.6 |
| 15 | 85.0 | 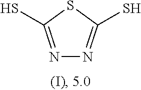 | 4.0 | 6.0 |
| 16 | 94.0 | 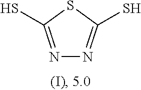 | 1.0 | N/A^{c} |
| 17 | 65.0 | 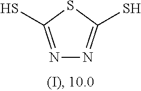 | 10.0 | 15.0 |
| 18 | 75.0 | 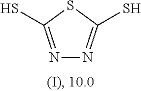 | 6.0 | 9.0 |
| 19 | 80.0 | 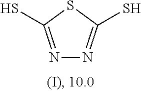 | 4.0 | 6.0 |
| 20 | 89.0 | 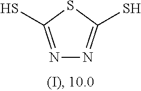 | 1.0 | N/A^{c} |
| 21 | 55.0 | 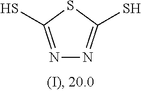 | 10.0 | 15.0 |
| 22 | 65.0 | 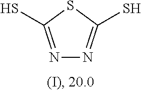 | 6.0 | 9.0 |
| 23 | 70.0 | 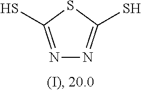 | 4.0 | 6.0 |
| 24 | 79.0 | 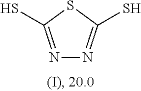 | 1.0 | N/A^{c} |
| 25 | 50.0 | 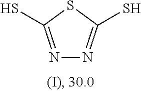 | 10.0 | 10.0 |
| 26 | 55.0 | 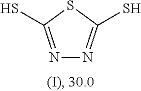 | 6.0 | 9.0 |
| 27 | 60.0 | 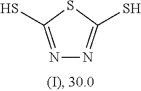 | 4.0 | 6.0 |
| 28 | 69.0 | 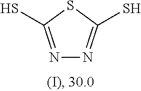 | 1.0 | N/A^{c} |
| 29 | 74.99 | 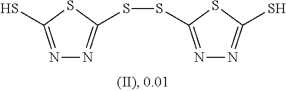 [SMILES: Sc1nnc(SSc2nnc(S)s2)s1] | 10.0 | 15.0 |
| 30 | 84.99 | 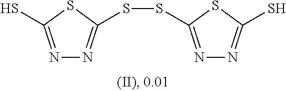 [SMILES: Sc1nnc(SSc2nnc(S)s2)s1] | 6.0 | 9.0 |
| 31 | 89.99 | 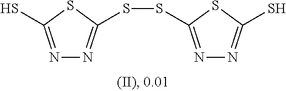 [SMILES: Sc1nnc(SSc2nnc(S)s2)s1] | 4.0 | 6.0 |
| 32 | 98.99 | 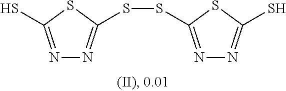 [SMILES: Sc1nnc(SSc2nnc(S)s2)s1] | 1.0 | N/A^{c} |
| 33 | 74.9 | 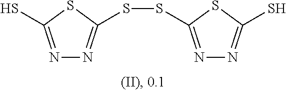 [SMILES: Sc1nnc(SSc2nnc(S)s2)s1] | 10.0 | 15.0 |
| 34 | 84.9 | 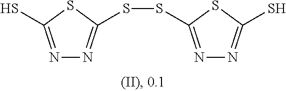 [SMILES: Sc1nnc(SSc2nnc(S)s2)s1] | 6.0 | 9.0 |
| 35 | 89.9 | 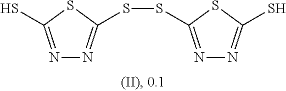 [SMILES: Sc1nnc(SSc2nnc(S)s2)s1] | 4.0 | 6.0 |
| 36 | 98.9 | 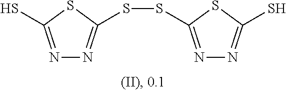 [SMILES: Sc1nnc(SSc2nnc(S)s2)s1] | 1.0 | N/A^{c} |
| 37 | 74.6 | 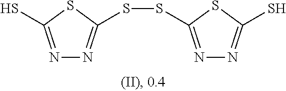 [SMILES: Sc1nnc(SSc2nnc(S)s2)s1] | 10.0 | 15.0 |
| 38 | 50.0 | 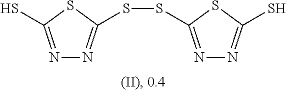 [SMILES: Sc1nnc(SSc2nnc(S)s2)s1] | 6.0 | 43.6 |
| 40 | 20.6 | 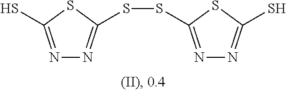 [SMILES: Sc1nnc(SSc2nnc(S)s2)s1] | 1.0 | 78.0 |
| 41 | 70.0 | 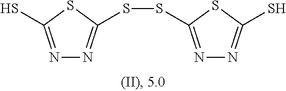 [SMILES: Sc1nnc(SSc2nnc(S)s2)s1] | 10.0 | 15.0 |
| 42 | 74.4 | 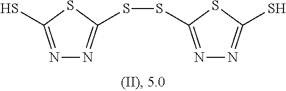 [SMILES: Sc1nnc(SSc2nnc(S)s2)s1] | 6.0 | 14.6 |
| 43 | 85.0 | 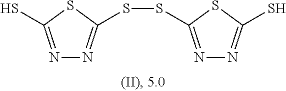 [SMILES: Sc1nnc(SSc2nnc(S)s2)s1] | 4.0 | 6.0 |
| 44 | 94.0 | 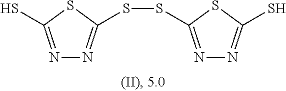 [SMILES: Sc1nnc(SSc2nnc(S)s2)s1] | 1.0 | N/A^{c} |
| 45 | 65.0 | 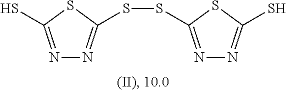 [SMILES: Sc1nnc(SSc2nnc(S)s2)s1] | 10.0 | 15.0 |
| 46 | 70.0 | 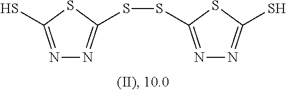 [SMILES: Sc1nnc(SSc2nnc(S)s2)s1] | 6.0 | 14.0 |
| 47 | 80.0 | 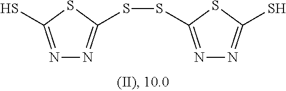 [SMILES: Sc1nnc(SSc2nnc(S)s2)s1] | 4.0 | 6.0 |
| 48 | 89.0 | 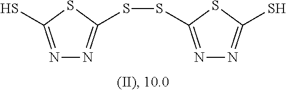 [SMILES: Sc1nnc(SSc2nnc(S)s2)s1] | 1.0 | N/A^{c} |
| 49 | 55.0 | 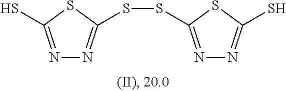 [SMILES: Sc1nnc(SSc2nnc(S)s2)s1] | 10.0 | 15.0 |
| 50 | 60.0 | 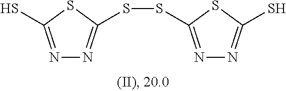 [SMILES: Sc1nnc(SSc2nnc(S)s2)s1] | 6.0 | 14.0 |
| 51 | 70.0 | 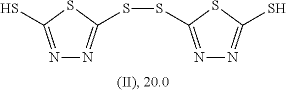 [SMILES: Sc1nnc(SSc2nnc(S)s2)s1] | 4.0 | 6.0 |
| 52 | 79.0 | 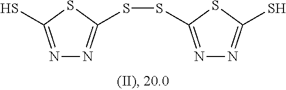 [SMILES: Sc1nnc(SSc2nnc(S)s2)s1] | 1.0 | N/A^{c} |
| 53 | 50.0 | 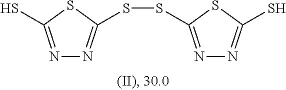 [SMILES: Sc1nnc(SSc2nnc(S)s2)s1] | 10.0 | 10.0 |
| 54 | 55.0 | 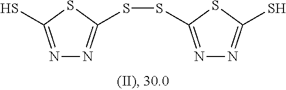 [SMILES: Sc1nnc(SSc2nnc(S)s2)s1] | 6.0 | 9.0 |
| 55 | 60.0 | 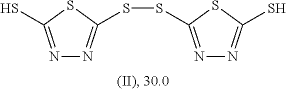 [SMILES: Sc1nnc(SSc2nnc(S)s2)s1] | 4.0 | 6.0 |
| 56 | 69.0 | 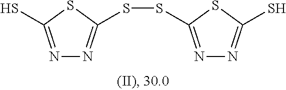 [SMILES: Sc1nnc(SSc2nnc(S)s2)s1] | 1.0 | N/A^{c} |
| 57 | 74.99 | 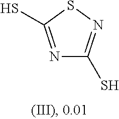 | 10.0 | 15.0 |
| 58 | 84.99 | 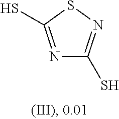 | 6.0 | 9.0 |
| 59 | 89.99 | 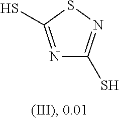 | 4.0 | 6.0 |
| 60 | 98.99 | 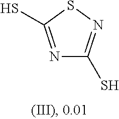 | 1.0 | N/A^{c} |
| 61 | 74.9 | 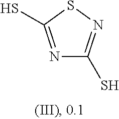 | 10.0 | 15.0 |
| 62 | 84.9 | 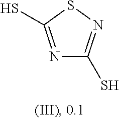 | 6.0 | 9.0 |
| 63 | 89.9 | 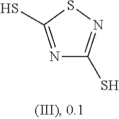 | 4.0 | 6.0 |
| 64 | 98.9 | 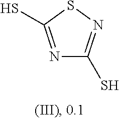 | 1.0 | N/A^{c} |
| 65 | 74.6 | 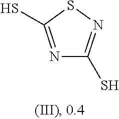 | 10.0 | 15.0 |
| 66 | 50.0 | 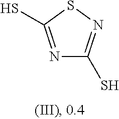 | 6 | 43.6 |
| 68 | 20.6 | 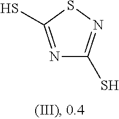 | 1.0 | 78.0 |
| 69 | 70.0 | 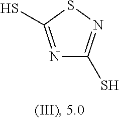 | 10.0 | 15.0 |
| 70 | 74.4 | 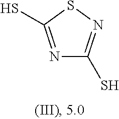 | 6.0 | 14.6 |
| 71 | 85.0 | 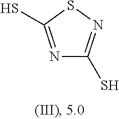 | 4.0 | 6.0 |
| 72 | 94.0 | 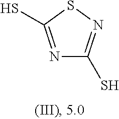 | 1.0 | N/A^{c} |
| 73 | 65.0 | 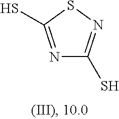 | 10.0 | 15.0 |
| 74 | 70.0 | 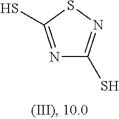 | 6.0 | 14.0 |
| 75 | 80.0 | 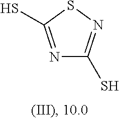 | 4.0 | 6.0 |
| 76 | 89.0 | 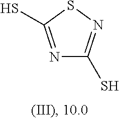 | 1.0 | N/A^{c} |
| 77 | 55.0 | 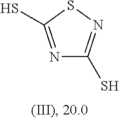 | 10.0 | 15.0 |
| 78 | 60.0 | 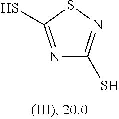 | 6.0 | 14.0 |
| 79 | 70.0 | 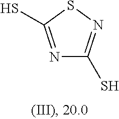 | 4.0 | 6.0 |
| 80 | 79.0 | 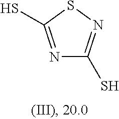 | 1.0 | N/A^{c} |
| 81 | 50.0 | 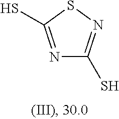 | 10.0 | 10.0 |
| 82 | 55.0 | 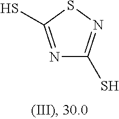 | 6.0 | 9.0 |
| 83 | 60.0 | 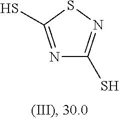 | 4.0 | 6.0 |
| 84 | 69.0 | 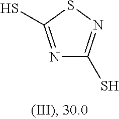 | 1.0 | N/A^{c} |
| 85 | 74.99 | 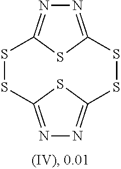 [SMILES: N1=C2SSc3nnc(s3)SSC(=N1)S2] | 10.0 | 15.0 |
| 86 | 84.99 | 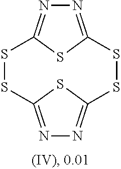 [SMILES: N1=C2SSc3nnc(s3)SSC(=N1)S2] | 6.0 | 9.0 |
| 87 | 89.99 | 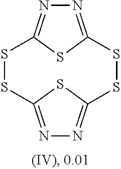 [SMILES: N1=C2SSc3nnc(s3)SSC(=N1)S2] | 4.0 | 6.0 |
| 88 | 98.99 | 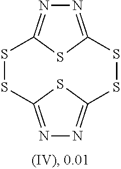 [SMILES: N1=C2SSc3nnc(s3)SSC(=N1)S2] | 1.0 | N/A^{c} |
| 89 | 74.9 | 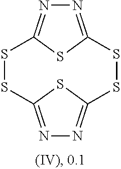 [SMILES: N1=C2SSc3nnc(s3)SSC(=N1)S2] | 10.0 | 15.0 |
| 90 | 84.9 | 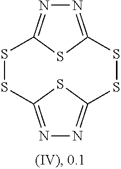 [SMILES: N1=C2SSc3nnc(s3)SSC(=N1)S2] | 6.0 | 9.0 |
| 91 | 89.9 | 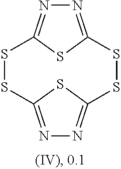 [SMILES: N1=C2SSc3nnc(s3)SSC(=N1)S2] | 4.0 | 6.0 |
| 92 | 98.9 | 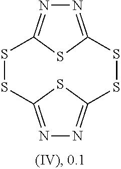 [SMILES: N1=C2SSc3nnc(s3)SSC(=N1)S2] | 1.0 | N/A^{c} |
| 93 | 74.6 | 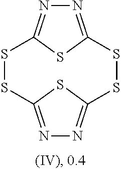 [SMILES: N1=C2SSc3nnc(s3)SSC(=N1)S2] | 10.0 | 15.0 |
| 94 | 50.0 | 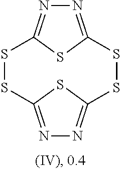 [SMILES: N1=C2SSc3nnc(s3)SSC(=N1)S2] | 6.0 | 43.6 |
| 96 | 20.6 | 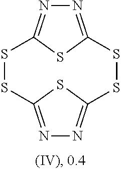 [SMILES: N1=C2SSc3nnc(s3)SSC(=N1)S2] | 1.0 | 78.0 |
| 97 | 70.0 | 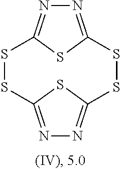 [SMILES: N1=C2SSc3nnc(s3)SSC(=N1)S2] | 10.0 | 15.0 |
| 98 | 74.4 | 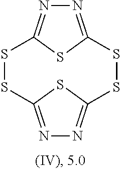 [SMILES: N1=C2SSc3nnc(s3)SSC(=N1)S2] | 6.0 | 14.6 |
| 99 | 85.0 | 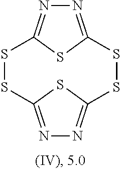 [SMILES: N1=C2SSc3nnc(s3)SSC(=N1)S2] | 4.0 | 6.0 |
| 100 | 94.0 | 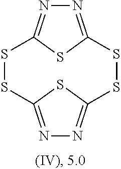 [SMILES: N1=C2SSc3nnc(s3)SSC(=N1)S2] | 1.0 | N/A^{c} |
| 101 | 65.0 | 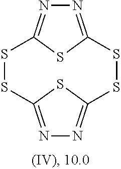 [SMILES: N1=C2SSc3nnc(s3)SSC(=N1)S2] | 10.0 | 15.0 |
| 102 | 70.0 | 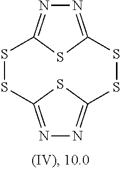 [SMILES: N1=C2SSc3nnc(s3)SSC(=N1)S2] | 6.0 | 14.0 |
| 103 | 80.0 | 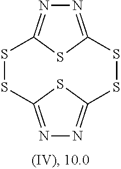 [SMILES: N1=C2SSc3nnc(s3)SSC(=N1)S2] | 4.0 | 6.0 |
| 104 | 89.0 | 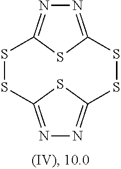 [SMILES: N1=C2SSc3nnc(s3)SSC(=N1)S2] | 1.0 | N/A^{c} |
| 105 | 55.0 | 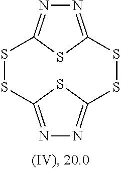 [SMILES: N1=C2SSc3nnc(s3)SSC(=N1)S2] | 10.0 | 15.0 |
| 106 | 60.0 | 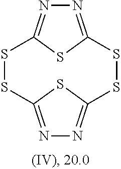 [SMILES: N1=C2SSc3nnc(s3)SSC(=N1)S2] | 6.0 | 14.0 |
| 107 | 70.0 | 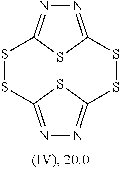 [SMILES: N1=C2SSc3nnc(s3)SSC(=N1)S2] | 4.0 | 6.0 |
| 108 | 79.0 | 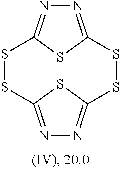 [SMILES: N1=C2SSc3nnc(s3)SSC(=N1)S2] | 1.0 | N/A^{c} |
| 109 | 50.0 | 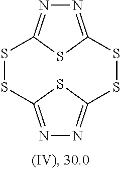 [SMILES: N1=C2SSc3nnc(s3)SSC(=N1)S2] | 10.0 | 10.0 |
| 110 | 55.0 | 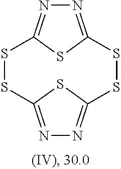 [SMILES: N1=C2SSc3nnc(s3)SSC(=N1)S2] | 6.0 | 9.0 |
| 111 | 60.0 | 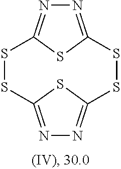 [SMILES: N1=C2SSc3nnc(s3)SSC(=N1)S2] | 4.0 | 6.0 |
| 112 | 69.0 | 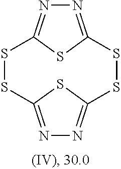 [SMILES: N1=C2SSc3nnc(s3)SSC(=N1)S2] | 1.0 | N/A^{c} |
| 113 | 74.99 | 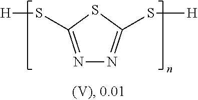 | 10.0 | 15.0 |
| 114 | 84.99 | 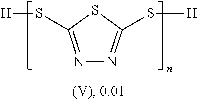 | 6.0 | 9.0 |
| 115 | 89.99 | 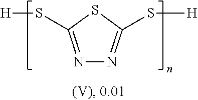 | 4.0 | 6.0 |
| 116 | 98.99 | 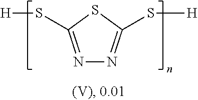 | 1.0 | N/A^{c} |
| 117 | 74.9 | 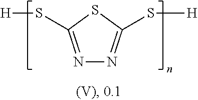 | 10.0 | 15.0 |
| 118 | 84.9 | 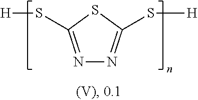 | 6.0 | 9.0 |
| 119 | 89.9 | 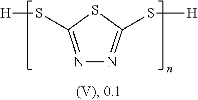 | 4.0 | 6.0 |
| 120 | 98.9 | 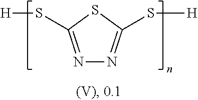 | 1.0 | N/A^{c} |
| 121 | 74.6 | 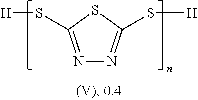 | 10.0 | 15.0 |
| 122 | 50.0 | 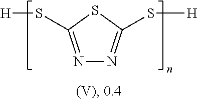 | 6.0 | 43.6 |
| 124 | 20.6 | 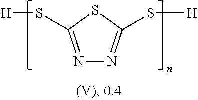 | 1.0 | 78.0 |
| 125 | 70.0 | 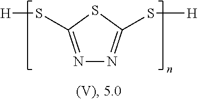 | 10.0 | 15.0 |
| 126 | 74.4 | 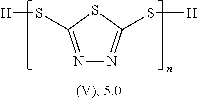 | 6.0 | 14.6 |
| 127 | 85.0 | 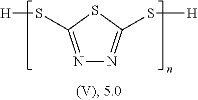 | 4.0 | 6.0 |
| 128 | 94.0 | 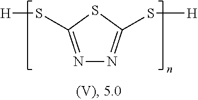 | 1.0 | N/A^{c} |
| 129 | 65.0 | 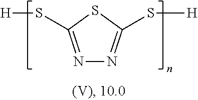 | 10.0 | 15.0 |
| 130 | 70.0 | 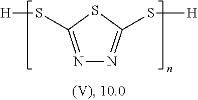 | 6.0 | 14.0 |
| 131 | 80.0 | 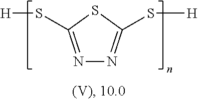 | 4.0 | 6.0 |
| 132 | 89.0 | 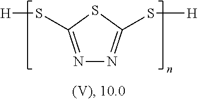 | 1.0 | N/A^{c} |
| 133 | 55.0 | 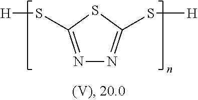 | 10.0 | 15.0 |
| 134 | 60.0 | 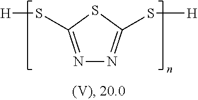 | 6.0 | 14.0 |
| 135 | 70.0 | 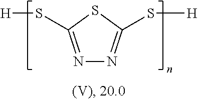 | 4.0 | 6.0 |
| 136 | 79.0 | 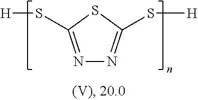 | 1.0 | N/A^{c} |
| 137 | 50.0 | 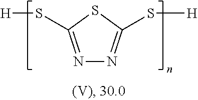 | 10.0 | 10.0 |
| 138 | 55.0 | 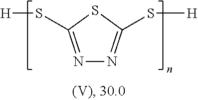 | 6.0 | 9.0 |
| 139 | 60.0 | 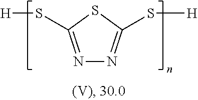 | 4.0 | 6.0 |
| 140 | 69.0 | 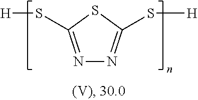 | 1.0 | N/A^{c} |

^{a}PVB, Polyvinyl Butyral is obtained from Eastman Chemical Co. (Kingsport, Tennessee (US)).
^{b}Solvent is ethanol.
^{c}N/A, not applicable, as the mixture is already at 100 g (that is, 100% (wt/wt)).

### Example 12

### Characterization of Coating Formulations by Linear Sweep Voltammetry and Chronoamperometry

Panel substrate preparation. Panel substrates selected for application of the resin were 7075-T6 bare aluminum because this material is widely used on aircraft internal structural parts where hexavalent chromium containing primers are found. Aluminum panels were prepared in accordance with BAC5663, Type I, Class 1, Grade B which entailed solvent cleaning, wet abrade with red Scotch-brite pad followed by washing in a 1:7 solution of Pace B-82 to water. Panels were rinsed with tap water and the water break free surface verified. Spray coated panels were 4″×6″, 7075-T6 bare alloy. The panels were solvent cleaned, wet abraded and coated with PVB resin with three different concentrations of DMcT. Additional aluminum panels (7075-T6 bare aluminum, 4″×4″×0.04″) were prepared for spin coating by washing the panels with methyl ethyl ketone solvent; washing the panels with soap and water with abrasion (1:8 PACE B-82:water, Scotch Brite pad on a hand sander), rinsing the panels with water and air-drying the panels.

Coating Application and Cure.

PVB coatings were sprayed with Devilbiss EXL spray gun in a paint booth with controlled temperature and humidity. The coatings were diluted with butanol solvent to enable a smooth spray out. Coatings were cured for 2 hours at approximately 160° F. followed by 7 days at ambient conditions. Thickness of the coatings was measured using an isoscope. These panels were used for neutral salt fog exposure. The coating thickness over the panel was inconsistent using a spray method and had to be diluted significantly to enable use of the spray gun.

The spin coater provided a more even distribution of the coating on the surface as compared to spray. Subsequent 4″×4″ panels were spin coated using a Chemat Technology KW-4A spin coater. Parameters initially were 500 RPM for 10 sec followed by 2000 rpm for 40 sec.

The spin coated panels were cured at −250° F. for 2 hr.

Open Circuit Potential of Coating—Panel as Working Electrode.

The open circuit potential was measured for panels with spray applied PVB coating with 0%, 0.5%, and 5% DMcT loading. A circular glass cell was clamped to the surface of the panel and filled with 5% (wt/wt) NaCl electrolyte buffered with phosphate buffer (NaCl (5% (wt/wt)-phosphate buffer saline (PBS)). The working electrode connectors were connected to the panel so the panel acted like the working electrode. The Ag/AgCl Calomel reference and platinum counter electrodes were placed in the electrolyte. Linear sweep voltammetry or other applied potential experiments were not run prior to these experiments to prevent disruption of the coating.

Linear Sweep Voltammetry and Chronoamperometry Experiments.

Linear sweep voltammetry (LSV) and chronoamperometry, both using a rotating disk electrode, were used to analyze the corrosion inhibition performance of the coatings.

The panels were subjected to 5% (wt/wt) sodium chloride in phosphate buffered saline (5% (wt/wt) NaCl—PBS) using a clamp cell configuration. Linear sweep voltammetry (LSV) and chronoamperometry were performed on the 5 coated panels using a Pine Model AFMSRCE rotating disk electrode rotator at 1000 rpm with a Series G-750 potentiostat, 750 microAmp version (PCI4G750-47062), with a platinum counter electrode, silver/silver chloride reference electrode, and a 99%+ pure copper disk (1 cm²) rotating working electrode. Running in parallel was an EG&G Princeton Applied Research Model 636 rotating disk electrode (RDE) rotator with a Series G-750 potentiostat, 750 microAmp version (PCI4300-33026). Gamry Framework software was used as the measurement tool for LSV and chronoamperometry.

LSV was run using an electrical potential scan applied between the working and reference electrodes from −0.3 to −1 volts with a scan rate of 10 mV/s. Chronoamperometry was run by stepping the working electrode potential to −0.8 volts and the resulting current of the electrode was measured for 1800 seconds (0.5 hr).

LSV and chronoamperometry were repeated 2-3 times on each sample, with an hour in between measurements. Conductivity, dissolved oxygen, and pH measurements of the 5% (wt/wt) NaCl/PBS on top of the panels were taken one time before and one time after all of the LSV and chronoamperometry repetitions.

### INCORPORATION BY REFERENCE

All publications, patents, and patent applications mentioned herein are hereby incorporated by reference in their entirety as if each individual publication, patent or patent application was specifically and individually indicated to be incorporated by reference. In case of conflict, the present application, including any definitions herein, will control.

The terminology used herein is for the purpose of describing particular embodiments only, and is not intended to be limiting. With respect to the use of substantially, any plural and/or singular terms herein, those having skill in the art can translate from the plural as is appropriate to the context and/or application. The various singular/plural permutations may be expressly set forth herein for the sake of clarity.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments or examples disclosed, but that the present invention will include all embodiments falling within the scope of the appended claims.

What is claimed is:

1. A corrosion inhibiting formulation comprising:
(a) at least one resin;
(b) at least one Brønsted acid; and
(c) at least one thio-containing corrosion inhibitor.

2. The corrosion inhibiting formulation of claim 1, wherein the at least one resin comprises a thermoplastic resin.

3. The corrosion inhibiting formulation of claim 2, wherein the thermoplastic resin is selected from a group consisting of: polyvinyl polymer, polyurethane polymer, acrylate polymer, and styrene polymer, or a combination thereof.

4. The corrosion inhibiting formulation of claim 2, wherein the thermoplastic resin comprises a polyvinyl polymer.

5. The corrosion inhibiting formulation of claim 4, wherein the polyvinyl polymer is selected from a group consisting of a polyvinyl acetal polymer, a polyvinyl butyral polymer and a polyvinyl formal polymer, or a combination thereof.

6. The corrosion inhibiting formulation of claim 4, wherein the polyvinyl polymer comprises a polyvinyl butyral polymer.

7. The corrosion inhibiting formulation of claim 1, wherein the at least one Brønsted acid is selected from a group consisting of H₃PO₄; H₂SO₄; HX, wherein X is Cl, Br or F; and HNO₃; or a combination thereof.

8. The corrosion inhibiting formulation of claim 1, wherein the at least one Brønsted acid comprises H₃PO₄.

9. The corrosion inhibiting formulation of claim 1, wherein the at least one thio-containing corrosion inhibitor comprises a thiadiazole compound.

10. The corrosion inhibiting formulation of claim 9, wherein the thiadiazole compound is selected from a group consisting of structures (I)-(V): 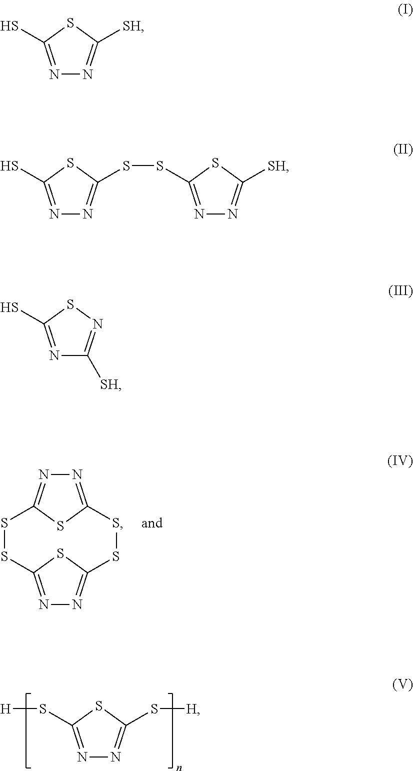
or a combination thereof, wherein n of structure (V) is equal to or greater than 2.

11. The corrosion inhibiting formulation of claim 9, wherein the thiadiazole compound is selected from a group consisting of: 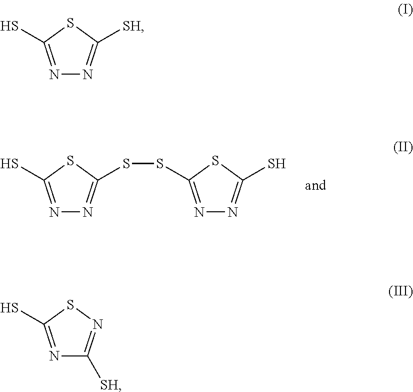 [SMILES: Sc1nnc(S)s1 ; Sc1nnc(SSc2nnc(S)s2)s1 ; Sc1nsc(S)n1]
or a combination thereof.

12. The corrosion inhibiting formulation of claim 1, wherein the at least one thio-containing corrosion inhibitor comprises a metal-containing thiadiazole compound.

13. The corrosion inhibiting formulation of claim 12, wherein the metal-containing thiadiazole compound is selected from a group consisting of:
2,5-dimercapto-1,3,4-thiadiazole, dipotassium salt; poly[Zn:2,5-dimercapto-1,3,4-thiadiazole (1:1)]; [Al:2,5-dimercapto-1,3,4-thiadiazole (1:3)]; [Al:2,5-dimercapto-1,3,4-thiadiazole (3:1)]; poly[Zn:(bis-(2,5-dithio-1,3,4-thiadiazole) (1:1)]; poly[Fe:2,5-dimercapto-1,3,4-thiadiazole) (1:1)]; poly[Al:2,5-dimercapto-1,3,4-thiadiazole (1:1)]; and poly[Cu:2,5-dimercapto-1,3,4-thiadiazole (1:1)]; or a combination thereof.

14. The corrosion inhibiting formulation of claim 12, wherein the metal-containing thiadiazole compound is poly[Zn:2,5-dimercapto-1,3,4-thiadiazole (1:1)].

15. The corrosion inhibiting formulation of claim 1, wherein:
the at least one resin is present in an amount ranging from about 8% (wt/wt) to about 99% (wt/wt);
the at least one Brønsted acid is present in an amount ranging from about 1% (wt/wt) to about 10% (wt/wt); and
the at least one thio-containing corrosion inhibitor is present in an amount ranging from about 0.01% (wt/wt) to about 30% (wt/wt).

16. The corrosion inhibiting formulation of claim 15, wherein:
the at least one resin comprises polyvinylbutaryl; and
the at least one Brønsted acid comprises H₃PO₄.

17. The corrosion inhibiting formulation of claim 16, wherein the at least one thio-containing corrosion inhibitor is selected from a group consisting of: 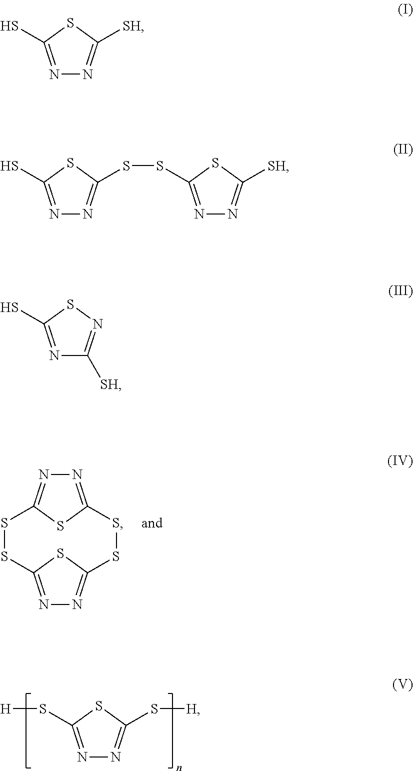
or a combination thereof, wherein n of structure (V) is equal to or greater than 2.

18. The corrosion inhibiting formulation of claim 17, wherein the corrosion inhibiting formulation is at least one of formulations (1)-(140):

| | Polyvinylbutyral | Thio-containing corrosion inhibitor | H₃PO₄ |
|---|---|---|---|
| Formulation | (% wt/wt) | (% wt/wt) | (% wt/wt) |
| 1 | 74.99 | 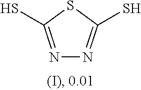 | 10.0 |
| 2 | 79.99 | 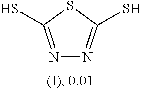 | 6.0 |
| 3 | 89.99 | 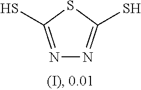 | 4.0 |
| 4 | 98.99 | 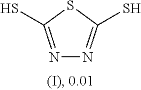 | 1.0 |
| 5 | 74.9 | 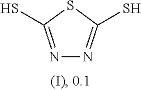 | 10.0 |
| 6 | 79.9 | 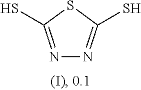 | 6.0 |
| 7 | 89.9 | 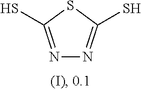 | 4.0 |
| 8 | 98.9 | 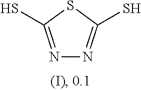 | 1.0 |
| 9 | 74.6 | 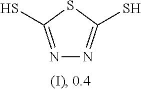 | 10.0 |
| 10 | 50.0 | 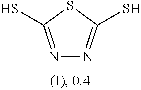 | 6.0 |
| 11 | 8.2 | 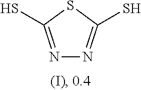 | 3.2 |
| 12 | 20.6 | 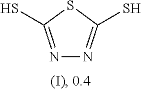 | 1.0 |
| 13 | 70.0 | 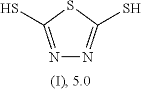 | 10.0 |
| 14 | 74.4 | 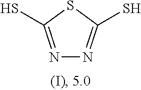 | 6.0 |
| 15 | 85.0 | 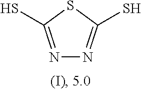 | 4.0 |
| 16 | 94.0 | 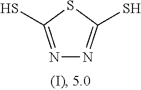 | 1.0 |
| 17 | 65.0 | 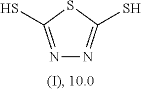 | 10.0 |
| 18 | 75.0 | 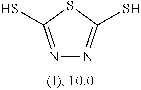 | 6.0 |
| 19 | 80.0 | 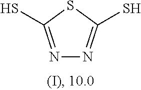 | 4.0 |
| 20 | 89.0 | 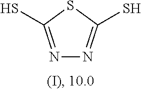 | 1.0 |
| 21 | 55.0 | 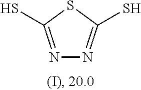 | 10.0 |
| 22 | 65.0 | 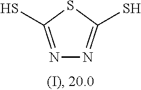 | 6.0 |
| 23 | 70.0 | 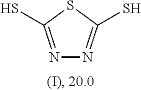 | 4.0 |
| 24 | 79.0 | 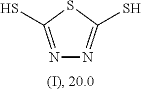 | 1.0 |
| 25 | 50.0 | 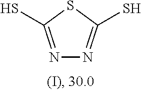 | 10.0 |
| 26 | 55.0 | 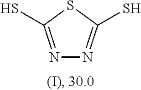 | 6.0 |
| 27 | 60.0 | 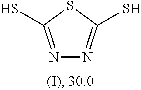 | 4.0 |
| 28 | 69.0 | 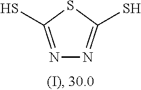 | 1.0 |
| 29 | 74.99 | 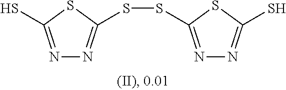 [SMILES: Sc1nnc(SSc2nnc(S)s2)s1] | 10.0 |
| 30 | 84.99 | 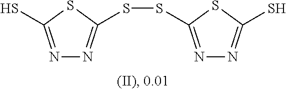 [SMILES: Sc1nnc(SSc2nnc(S)s2)s1] | 6.0 |
| 31 | 89.99 | 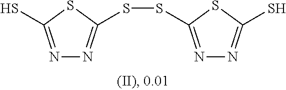 [SMILES: Sc1nnc(SSc2nnc(S)s2)s1] | 4.0 |
| 32 | 98.99 | 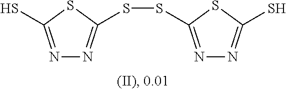 [SMILES: Sc1nnc(SSc2nnc(S)s2)s1] | 1.0 |
| 33 | 74.9 | 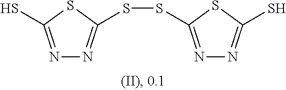 [SMILES: Sc1nnc(SSc2nnc(S)s2)s1] | 10.0 |
| 34 | 84.9 | 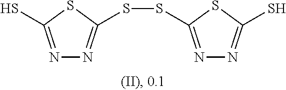 [SMILES: Sc1nnc(SSc2nnc(S)s2)s1] | 6.0 |
| 35 | 89.9 | 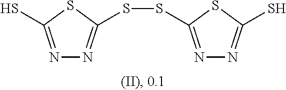 [SMILES: Sc1nnc(SSc2nnc(S)s2)s1] | 4.0 |
| 36 | 98.9 | 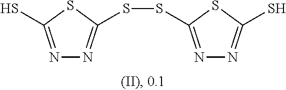 [SMILES: Sc1nnc(SSc2nnc(S)s2)s1] | 1.0 |
| 37 | 74.6 | 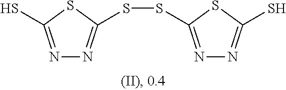 [SMILES: Sc1nnc(SSc2nnc(S)s2)s1] | 10.0 |
| 38 | 50.0 | 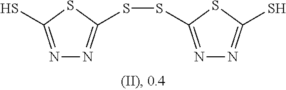 [SMILES: Sc1nnc(SSc2nnc(S)s2)s1] | 6.0 |
| 39 | 8.2 | 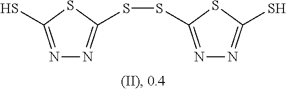 [SMILES: Sc1nnc(SSc2nnc(S)s2)s1] | 3.2 |
| 40 | 20.6 | 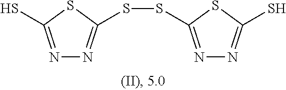 [SMILES: Sc1nnc(SSc2nnc(S)s2)s1] | 1.0 |
| 41 | 70.0 | 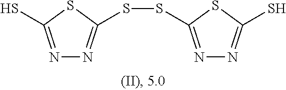 [SMILES: Sc1nnc(SSc2nnc(S)s2)s1] | 10.0 |
| 42 | 74.4 | 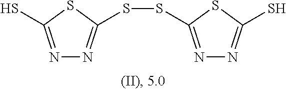 [SMILES: Sc1nnc(SSc2nnc(S)s2)s1] | 6.0 |
| 43 | 85.0 | 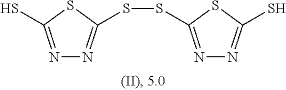 [SMILES: Sc1nnc(SSc2nnc(S)s2)s1] | 4.0 |
| 44 | 94.0 | 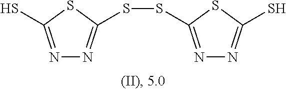 [SMILES: Sc1nnc(SSc2nnc(S)s2)s1] | 1.0 |
| 45 | 65.0 | 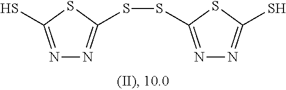 [SMILES: Sc1nnc(SSc2nnc(S)s2)s1] | 10.0 |
| 46 | 70.0 | 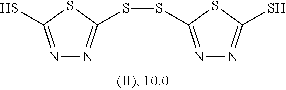 [SMILES: Sc1nnc(SSc2nnc(S)s2)s1] | 6.0 |
| 47 | 80.0 | 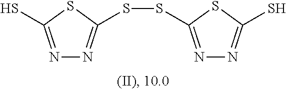 [SMILES: Sc1nnc(SSc2nnc(S)s2)s1] | 4.0 |
| 48 | 89.0 | 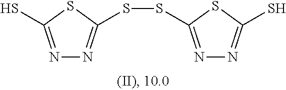 [SMILES: Sc1nnc(SSc2nnc(S)s2)s1] | 1.0 |
| 49 | 55.0 | 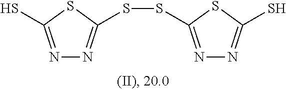 [SMILES: Sc1nnc(SSc2nnc(S)s2)s1] | 10.0 |
| 50 | 60.0 | 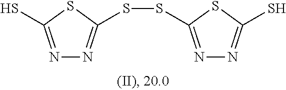 [SMILES: Sc1nnc(SSc2nnc(S)s2)s1] | 6.0 |
| 51 | 70.0 | 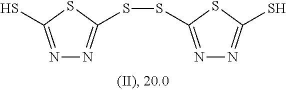 [SMILES: Sc1nnc(SSc2nnc(S)s2)s1] | 4.0 |
| 52 | 79.0 | 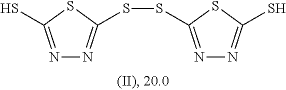 [SMILES: Sc1nnc(SSc2nnc(S)s2)s1] | 1.0 |
| 53 | 50.0 | 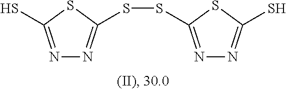 [SMILES: Sc1nnc(SSc2nnc(S)s2)s1] | 10.0 |
| 54 | 55.0 | 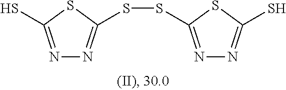 [SMILES: Sc1nnc(SSc2nnc(S)s2)s1] | 6.0 |
| 55 | 60.0 | 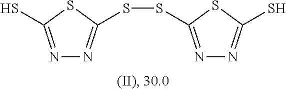 [SMILES: Sc1nnc(SSc2nnc(S)s2)s1] | 4.0 |
| 56 | 69.0 | 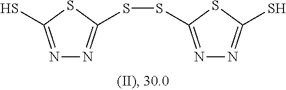 [SMILES: Sc1nnc(SSc2nnc(S)s2)s1] | 1.0 |
| 57 | 74.99 | 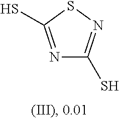 | 10.0 |
| 58 | 84.99 | 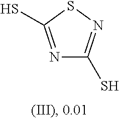 | 6.0 |
| 59 | 89.99 | 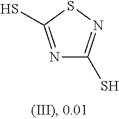 | 4.0 |
| 60 | 98.99 | 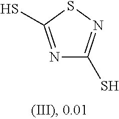 | 1.0 |
| 61 | 74.9 | 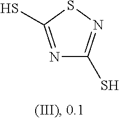 | 10.0 |
| 62 | 84.9 | 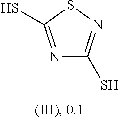 | 6.0 |
| 63 | 89.9 | 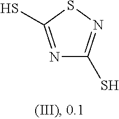 | 4.0 |
| 64 | 98.9 | 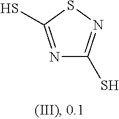 | 1.0 |
| 65 | 74.6 | 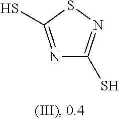 | 10.0 |
| 66 | 50.0 | 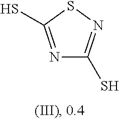 | 6.0 |
| 67 | 8.2 | 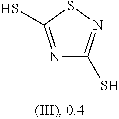 | 3.2 |
| 68 | 20.6 | 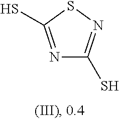 | 1.0 |
| 69 | 70.0 | 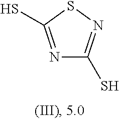 | 10.0 |
| 70 | 74.4 | 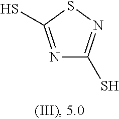 | 6.0 |
| 71 | 85.0 | 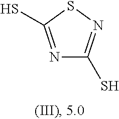 | 4.0 |
| 72 | 94.0 | 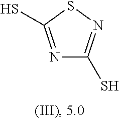 | 1.0 |
| 73 | 65.0 | 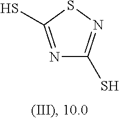 | 10.0 |
| 74 | 70.0 | 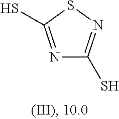 | 6.0 |
| 75 | 80.0 | 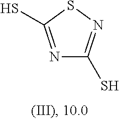 | 4.0 |
| 76 | 89.0 | 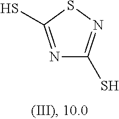 | 1.0 |
| 77 | 55.0 | 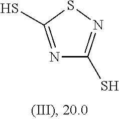 | 10.0 |
| 78 | 60.0 | 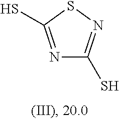 | 6.0 |
| 79 | 70.0 | 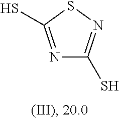 | 4.0 |
| 80 | 79.0 | 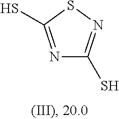 | 1.0 |
| 81 | 50.0 | 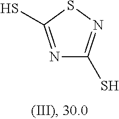 | 10.0 |
| 82 | 55.0 | 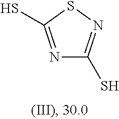 | 6.0 |
| 83 | 60.0 | 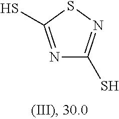 | 4.0 |
| 84 | 69.0 | 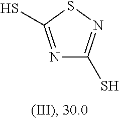 | 1.0 |
| 85 | 74.99 | 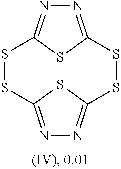 [SMILES: N1=C2SSc3nnc(s3)SSC(=N1)S2] | 10.0 |
| 86 | 84.99 | 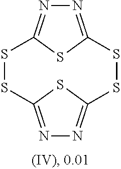 [SMILES: N1=C2SSc3nnc(s3)SSC(=N1)S2] | 6.0 |
| 87 | 89.99 | 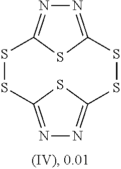 [SMILES: N1=C2SSc3nnc(s3)SSC(=N1)S2] | 4.0 |
| 88 | 98.99 | 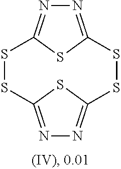 [SMILES: N1=C2SSc3nnc(s3)SSC(=N1)S2] | 1.0 |
| 89 | 74.9 | 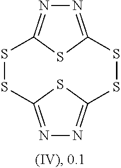 [SMILES: N1=C2SSc3nnc(s3)SSC(=N1)S2] | 10.0 |
| 90 | 84.9 | 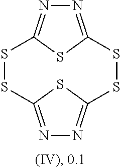 [SMILES: N1=C2SSc3nnc(s3)SSC(=N1)S2] | 6.0 |
| 91 | 89.9 | 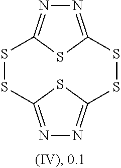 [SMILES: N1=C2SSc3nnc(s3)SSC(=N1)S2] | 4.0 |
| 92 | 98.9 | 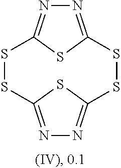 [SMILES: N1=C2SSc3nnc(s3)SSC(=N1)S2] | 1.0 |
| 93 | 74.6 | 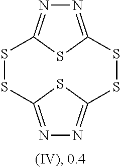 [SMILES: N1=C2SSc3nnc(s3)SSC(=N1)S2] | 10.0 |
| 94 | 50.0 | 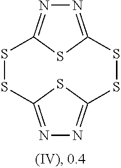 [SMILES: N1=C2SSc3nnc(s3)SSC(=N1)S2] | 6.0 |
| 95 | 8.2 | 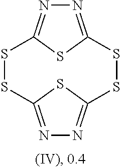 [SMILES: N1=C2SSc3nnc(s3)SSC(=N1)S2] | 3.2 |
| 96 | 20.6 | 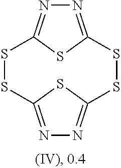 [SMILES: N1=C2SSc3nnc(s3)SSC(=N1)S2] | 1.0 |
| 97 | 70.0 | 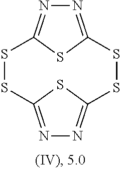 [SMILES: N1=C2SSc3nnc(s3)SSC(=N1)S2] | 10.0 |
| 98 | 74.4 | 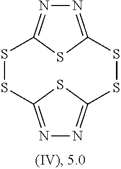 [SMILES: N1=C2SSc3nnc(s3)SSC(=N1)S2] | 6.0 |
| 99 | 85.0 | 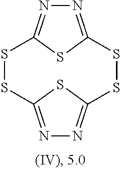 [SMILES: N1=C2SSc3nnc(s3)SSC(=N1)S2] | 4.0 |
| 100 | 94.0 | 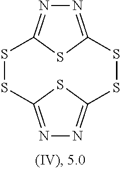 [SMILES: N1=C2SSc3nnc(s3)SSC(=N1)S2] | 1.0 |
| 101 | 65.0 | 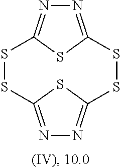 [SMILES: N1=C2SSc3nnc(s3)SSC(=N1)S2] | 10.0 |
| 102 | 70.0 | 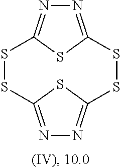 [SMILES: N1=C2SSc3nnc(s3)SSC(=N1)S2] | 6.0 |
| 103 | 80.0 | 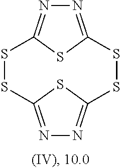 [SMILES: N1=C2SSc3nnc(s3)SSC(=N1)S2] | 4.0 |
| 104 | 89.0 | 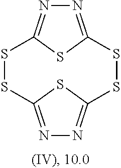 [SMILES: N1=C2SSc3nnc(s3)SSC(=N1)S2] | 1.0 |
| 105 | 55.0 | 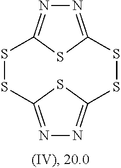 [SMILES: N1=C2SSc3nnc(s3)SSC(=N1)S2] | 10.0 |
| 106 | 60.0 | 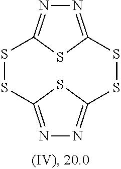 [SMILES: N1=C2SSc3nnc(s3)SSC(=N1)S2] | 6.0 |
| 107 | 70.0 | 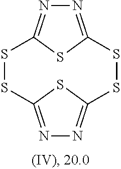 [SMILES: N1=C2SSc3nnc(s3)SSC(=N1)S2] | 4.0 |
| 108 | 79.0 | 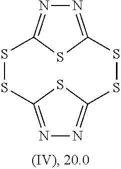 [SMILES: N1=C2SSc3nnc(s3)SSC(=N1)S2] | 1.0 |
| 109 | 50.0 | 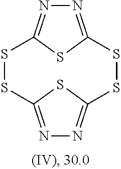 [SMILES: N1=C2SSc3nnc(s3)SSC(=N1)S2] | 10.0 |
| 110 | 55.0 | 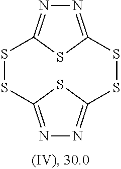 [SMILES: N1=C2SSc3nnc(s3)SSC(=N1)S2] | 6.0 |
| 111 | 60.0 | 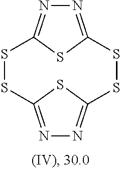 [SMILES: N1=C2SSc3nnc(s3)SSC(=N1)S2] | 4.0 |
| 112 | 69.0 | 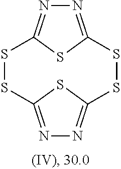 [SMILES: N1=C2SSc3nnc(s3)SSC(=N1)S2] | 1.0 |
| 113 | 74.99 | 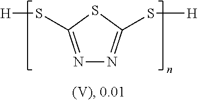 | 10.0 |
| 114 | 84.99 | 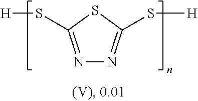 | 6.0 |
| 115 | 89.99 | 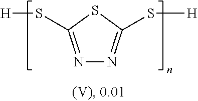 | 4.0 |
| 116 | 98.99 | 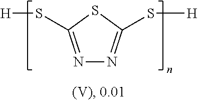 | 1.0 |
| 117 | 74.9 | 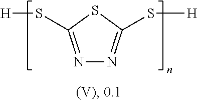 | 10.0 |
| 118 | 84.9 | 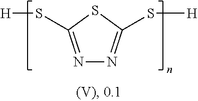 | 6.0 |
| 119 | 89.9 | 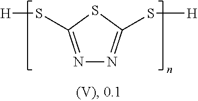 | 4.0 |
| 120 | 98.9 | 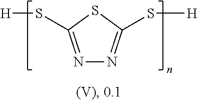 | 1.0 |
| 121 | 74.6 | 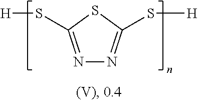 | 10.0 |
| 122 | 50.0 | 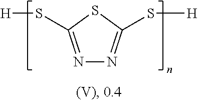 | 6.0 |
| 123 | 8.2 | 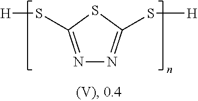 | 3.2 |
| 124 | 20.6 | 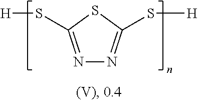 | 1.0 |
| 125 | 70.0 | 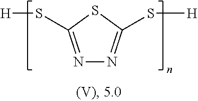 | 10.0 |
| 126 | 74.4 | 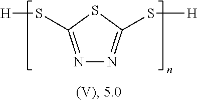 | 6.0 |
| 127 | 85.0 | 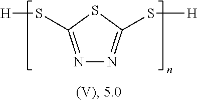 | 4.0 |
| 128 | 94.0 | 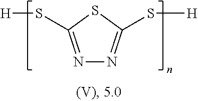 | 1.0 |
| 129 | 65.0 | 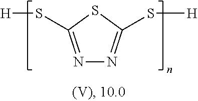 | 10.0 |
| 130 | 70.0 | 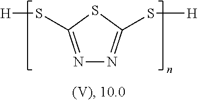 | 6.0 |
| 131 | 80.0 | 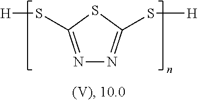 | 4.0 |
| 132 | 89.0 | 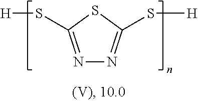 | 1.0 |
| 133 | 55.0 | 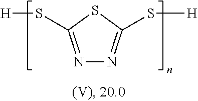 | 10.0 |
| 134 | 60.0 | 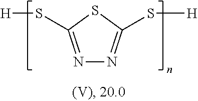 | 6.0 |
| 135 | 70.0 | 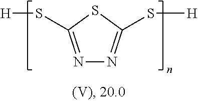 | 4.0 |
| 136 | 79.0 | 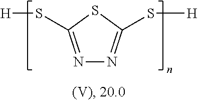 | 1.0 |
| 137 | 50.0 | 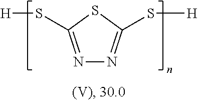 | 10.0 |
| 138 | 55.0 | 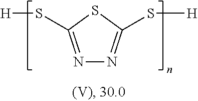 | 6.0 |
| 139 | 60.0 | 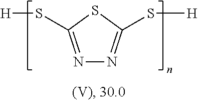 | 4.0 |
| 140 | 69.0 | 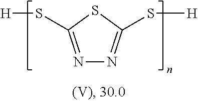 | 1.0 |

19. A substrate coating comprising a corrosion inhibiting formulation of claim 1.

20. The substrate coating of claim 19, wherein the at least one resin comprises a thermoplastic resin.

21. The substrate coating of claim 20, wherein the thermoplastic resin is selected from a group consisting of a polyvinyl polymer, a polyurethane polymer, an acrylate polymer and a styrene polymer, or a combination thereof.

22. The substrate coating of claim 20, wherein the thermoplastic resin comprises a polyvinyl polymer.

23. The substrate coating of claim 22, wherein the polyvinyl polymer is selected from a group consisting of a polyvinyl acetal polymer, a polyvinyl butyral polymer and a polyvinyl formal polymer, or a combination thereof.

24. The substrate coating of claim 22, wherein the polyvinyl polymer comprises a polyvinyl butyral polymer.

25. The substrate coating of claim 19, wherein the at least one Brønsted acid is selected from a group consisting of H₃PO₄; H₂SO₄; HX, wherein X is Cl, Br or F; and HNO₃; or a combination thereof.

26. The substrate coating of claim 19, wherein the at least one Brønsted acid comprises H₃PO₄.

27. The substrate coating of claim 19, wherein the at least one thio-containing corrosion inhibitor comprises a thiadiazole compound.

28. The substrate coating of claim 27, wherein the thiadiazole compound is selected from a group consisting of structures (I)-(V): 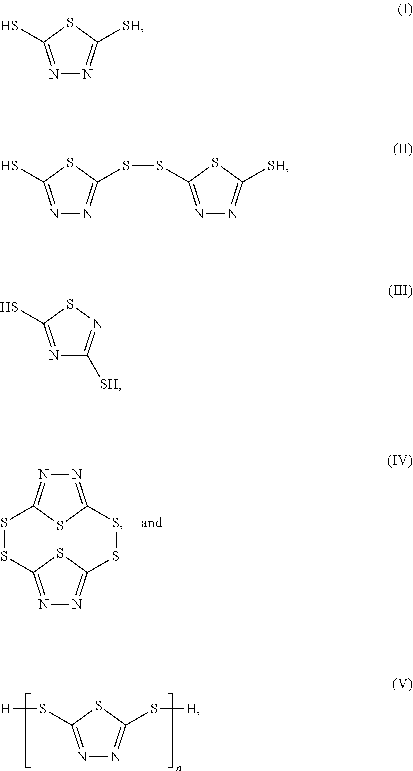
or a combination thereof, wherein n of structure (V) is equal to or greater than 2.

29. The substrate coating of claim 27, wherein the thiadiazole compound is selected from a group consisting of: 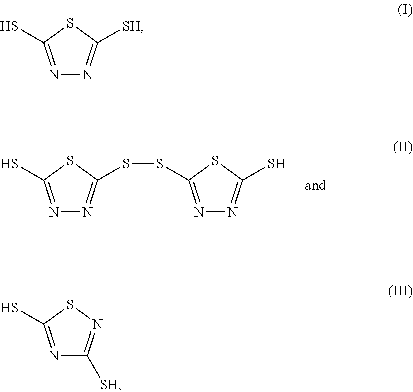 [SMILES: Sc1nnc(S)s1 ; Sc1nnc(SSc2nnc(S)s2)s1 ; Sc1nsc(S)n1]
or a combination thereof.

30. The substrate coating of claim 19, wherein the at least one thio-containing corrosion inhibitor comprises a metal-containing thiadiazole compound.

31. The substrate coating of claim 30, wherein the metal-containing thiadiazole compound is selected from the group consisting of:
2,5-dimercapto-1,3,4-thiadiazole, dipotassium salt; poly[Zn:2,5-dimercapto-1,3,4-thiadiazole (1:1)]; [Al:2,5-dimercapto-1,3,4-thiadiazole (1:3)]; [Al:2,5-dimercapto-1,3,4-thiadiazole (3:1)]; poly[Zn:(bis-(2,5-dithio-1,3,4-thiadiazole) (1:1)]; poly[Fe:2,5-dimercapto-1,3,4-thiadiazole) (1:1)]; poly[Al:2,5-dimercapto-1,3,4-thiadiazole (1:1)]; and poly[Cu:2,5-dimercapto-1,3,4-thiadiazole (1:1)]; or a combination thereof.

32. The substrate coating of claim 30, wherein the metal-containing thiadiazole compound is poly[Zn:2,5-dimercapto-1,3,4-thiadiazole (1:1)].

33. The substrate coating of claim 19, wherein:
the at least one resin is present in an amount ranging from about 50% (wt/wt) to about 99% (wt/wt);
the at least one Brønsted acid is present in an amount ranging from about 1% (wt/wt) to about 10% (wt/wt); and
the at least one thio-containing corrosion inhibitor is present in an amount ranging from about 0.01% (wt/wt) to about 30% (wt/wt).

34. The substrate coating of claim 33, wherein:
the at least one resin comprises polyvinylbutaryl; and
the at least one Brønsted acid comprises H₃PO₄.

35. The substrate coating of claim 34, wherein the at least one thio-containing corrosion inhibitor is selected from a group consisting of: 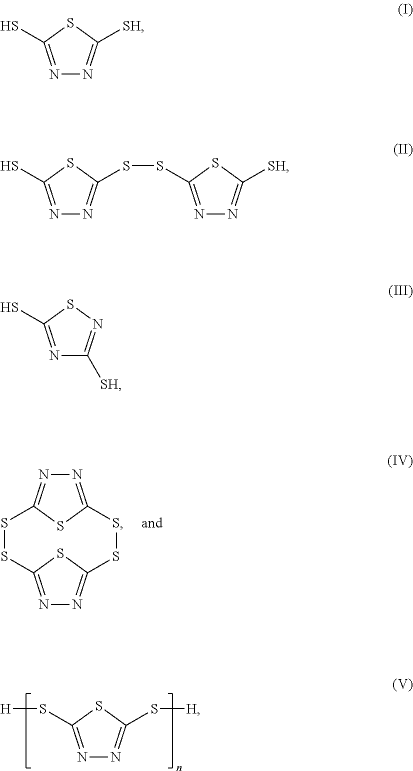
or a combination thereof, wherein n of structure (V) is equal to or greater than 2.

36. The substrate coating of claim 35, wherein the corrosion inhibiting formulation is at least one of formulations (1)-(140):

| | Poly- | | |
|---|---|---|---|
| | vinyl- | | |
| Form- | butyral | | H₃PO₄ |
| ula- | (% wt/ | Thio-containing corrosion inhibitor | (% wt/ |
| tion | wt) | (% wt/wt) | wt) |
| 1 | 74.99 | 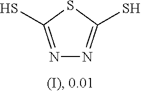 | 10.0 |
| 2 | 79.99 | 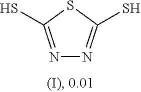 | 6.0 |
| 3 | 89.99 | 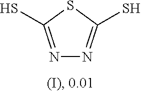 | 4.0 |
| 4 | 98.99 | 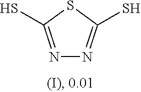 | 1.0 |
| 5 | 74.9 | 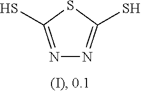 | 10.0 |
| 6 | 79.9 | 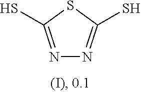 | 6.0 |
| 7 | 89.9 | 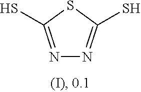 | 4.0 |
| 8 | 98.9 | 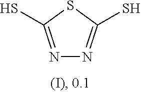 | 1.0 |
| 9 | 74.6 | 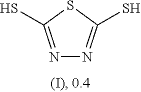 | 10.0 |
| 10 | 50.0 | 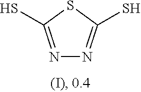 | 6.0 |
| 11 | 8.2 | 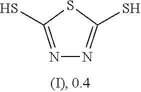 | 3.2 |
| 12 | 20.6 | 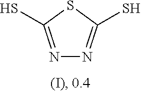 | 1.0 |
| 13 | 70.0 | 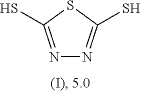 | 10.0 |
| 14 | 74.4 | 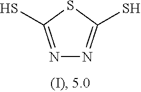 | 6.0 |
| 15 | 85.0 | 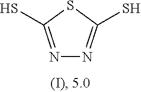 | 4.0 |
| 16 | 94.0 | 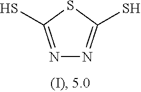 | 1.0 |
| 17 | 65.0 | 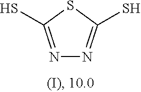 | 10.0 |
| 18 | 75.0 | 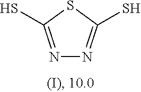 | 6.0 |
| 19 | 8.0 | 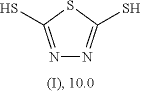 | 4.0 |
| 20 | 89.0 | 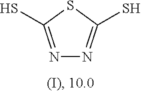 | 1.0 |
| 21 | 55.0 | 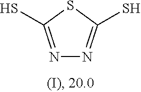 | 10.0 |
| 22 | 65.0 | 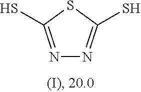 | 6.0 |
| 23 | 70.0 | 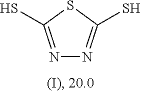 | 4.0 |
| 24 | 79.0 | 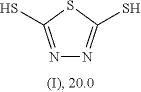 | 1.0 |
| 25 | 50.0 | 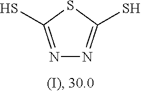 | 10.0 |
| 26 | 55.0 | 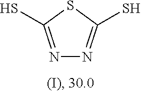 | 6.0 |
| 27 | 60.0 | 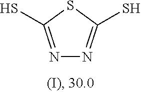 | 4.0 |
| 28 | 69.0 | 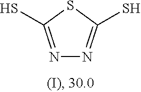 | 1.0 |
| 29 | 74.99 | 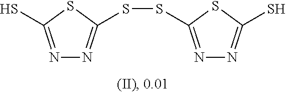 [SMILES: Sc1nnc(SSc2nnc(S)s2)s1] | 10.0 |
| 30 | 84.99 | 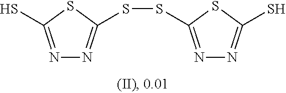 [SMILES: Sc1nnc(SSc2nnc(S)s2)s1] | 6.0 |
| 31 | 89.99 | 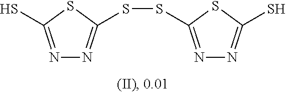 [SMILES: Sc1nnc(SSc2nnc(S)s2)s1] | 4.0 |
| 32 | 98.99 | 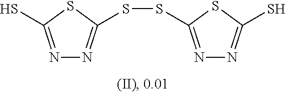 [SMILES: Sc1nnc(SSc2nnc(S)s2)s1] | 1.0 |
| 33 | 74.9 | 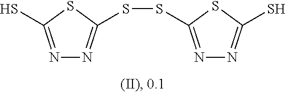 [SMILES: Sc1nnc(SSc2nnc(S)s2)s1] | 10.0 |
| 34 | 84.9 | 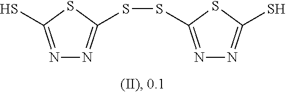 [SMILES: Sc1nnc(SSc2nnc(S)s2)s1] | 6.0 |
| 35 | 89.9 | 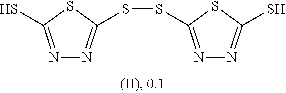 [SMILES: Sc1nnc(SSc2nnc(S)s2)s1] | 4.0 |
| 36 | 98.9 | 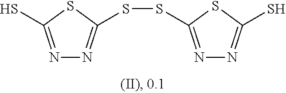 [SMILES: Sc1nnc(SSc2nnc(S)s2)s1] | 1.0 |
| 37 | 74.6 | 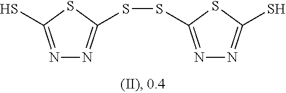 [SMILES: Sc1nnc(SSc2nnc(S)s2)s1] | 10.0 |
| 38 | 50.0 | 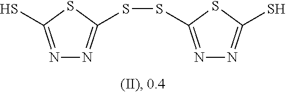 [SMILES: Sc1nnc(SSc2nnc(S)s2)s1] | 6.0 |
| 39 | 8.2 | 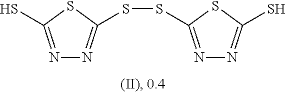 [SMILES: Sc1nnc(SSc2nnc(S)s2)s1] | 3.2 |
| 40 | 20.6 | 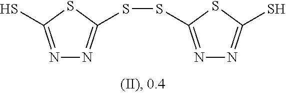 [SMILES: Sc1nnc(SSc2nnc(S)s2)s1] | 1.0 |
| 41 | 70.0 | 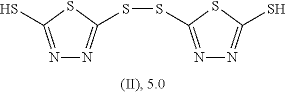 [SMILES: Sc1nnc(SSc2nnc(S)s2)s1] | 10.0 |
| 42 | 74.4 | 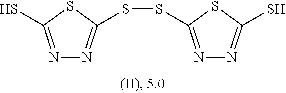 [SMILES: Sc1nnc(SSc2nnc(S)s2)s1] | 6.0 |
| 43 | 85.0 | 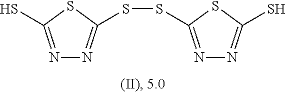 [SMILES: Sc1nnc(SSc2nnc(S)s2)s1] | 4.0 |
| 44 | 94.0 | 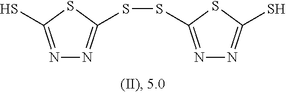 [SMILES: Sc1nnc(SSc2nnc(S)s2)s1] | 1.0 |
| 45 | 65.0 | 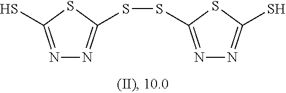 [SMILES: Sc1nnc(SSc2nnc(S)s2)s1] | 10.0 |
| 46 | 70.0 | 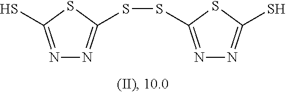 [SMILES: Sc1nnc(SSc2nnc(S)s2)s1] | 6.0 |
| 47 | 80.0 | 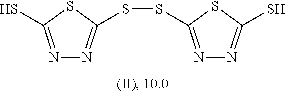 [SMILES: Sc1nnc(SSc2nnc(S)s2)s1] | 4.0 |
| 48 | 89.0 | 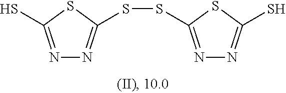 [SMILES: Sc1nnc(SSc2nnc(S)s2)s1] | 1.0 |
| 49 | 55.0 | 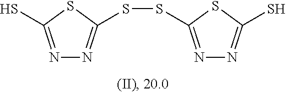 [SMILES: Sc1nnc(SSc2nnc(S)s2)s1] | 10.0 |
| 50 | 60.0 | 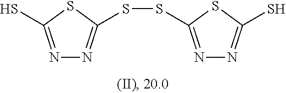 [SMILES: Sc1nnc(SSc2nnc(S)s2)s1] | 6.0 |
| 51 | 70.0 | 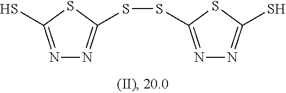 [SMILES: Sc1nnc(SSc2nnc(S)s2)s1] | 4.0 |
| 52 | 79.0 | 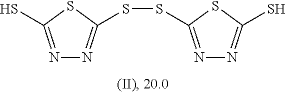 [SMILES: Sc1nnc(SSc2nnc(S)s2)s1] | 1.0 |
| 53 | 50.0 | 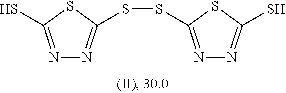 [SMILES: Sc1nnc(SSc2nnc(S)s2)s1] | 10.0 |
| 54 | 55.0 | 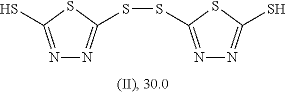 [SMILES: Sc1nnc(SSc2nnc(S)s2)s1] | 6.0 |
| 55 | 60.0 | 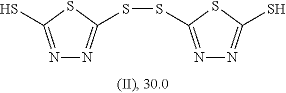 [SMILES: Sc1nnc(SSc2nnc(S)s2)s1] | 4.0 |
| 56 | 69.0 | 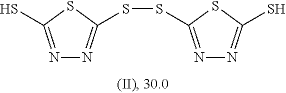 [SMILES: Sc1nnc(SSc2nnc(S)s2)s1] | 1.0 |
| 57 | 74.99 | 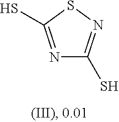 | 10.0 |
| 58 | 84.99 | 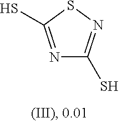 | 6.0 |
| 59 | 89.99 | 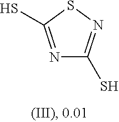 | 4.0 |
| 60 | 98.99 | 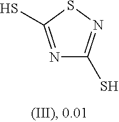 | 1.0 |
| 61 | 74.9 | 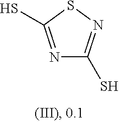 | 10.0 |
| 62 | 84.9 | 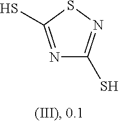 | 6.0 |
| 63 | 89.9 | 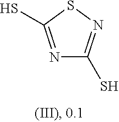 | 4.0 |
| 64 | 98.9 | 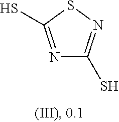 | 1.0 |
| 65 | 74.6 | 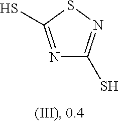 | 10.0 |
| 66 | 50.0 | 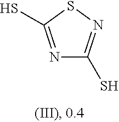 | 6.0 |
| 67 | 8.2 | 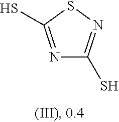 | 3.2 |
| 68 | 20.6 | 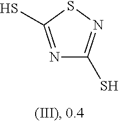 | 1.0 |
| 69 | 70.0 | 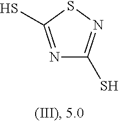 | 10.0 |
| 70 | 74.4 | 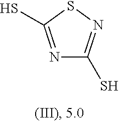 | 6.0 |
| 71 | 85.0 | 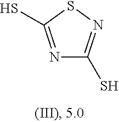 | 4.0 |
| 72 | 94.0 | 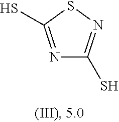 | 1.0 |
| 73 | 65.0 | 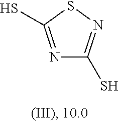 | 10.0 |
| 74 | 70.0 | 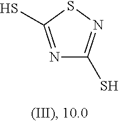 | 6.0 |
| 75 | 80.0 | 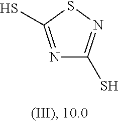 | 4.0 |
| 76 | 89.0 | 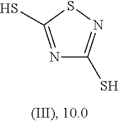 | 1.0 |
| 77 | 55.0 | 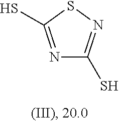 | 10.0 |
| 78 | 60.0 | 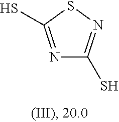 | 6.0 |
| 79 | 70.0 | 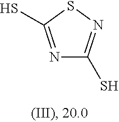 | 4.0 |
| 80 | 79.0 | 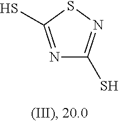 | 1.0 |
| 81 | 50.0 | 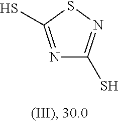 | 10.0 |
| 82 | 55.0 | 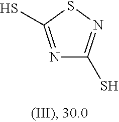 | 6.0 |
| 83 | 60.0 | 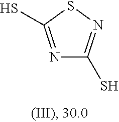 | 4.0 |
| 84 | 69.0 | 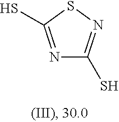 | 1.0 |
| 85 | 74.99 | 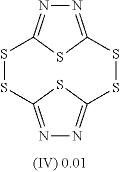 [SMILES: N1=C2SSc3nnc(s3)SSC(=N1)S2] | 10.0 |
| 86 | 84.99 | 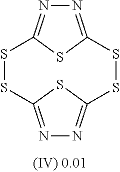 [SMILES: N1=C2SSc3nnc(s3)SSC(=N1)S2] | 6.0 |
| 87 | 89.99 | 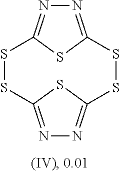 [SMILES: N1=C2SSc3nnc(s3)SSC(=N1)S2] | 4.0 |
| 88 | 98.99 | 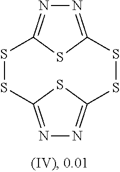 [SMILES: N1=C2SSc3nnc(s3)SSC(=N1)S2] | 1.0 |
| 89 | 74.9 | 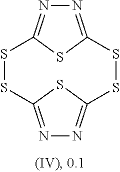 [SMILES: N1=C2SSc3nnc(s3)SSC(=N1)S2] | 10.0 |
| 90 | 84.9 | 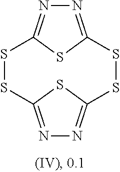 [SMILES: N1=C2SSc3nnc(s3)SSC(=N1)S2] | 6.0 |
| 91 | 89.9 | 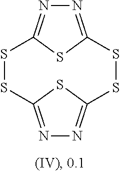 [SMILES: N1=C2SSc3nnc(s3)SSC(=N1)S2] | 4.0 |
| 92 | 98.9 | 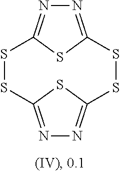 [SMILES: N1=C2SSc3nnc(s3)SSC(=N1)S2] | 1.0 |
| 93 | 74.6 | 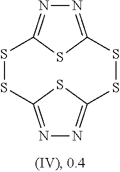 [SMILES: N1=C2SSc3nnc(s3)SSC(=N1)S2] | 10.0 |
| 94 | 50.0 | 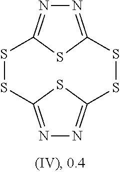 [SMILES: N1=C2SSc3nnc(s3)SSC(=N1)S2] | 6.0 |
| 95 | 8.2 | 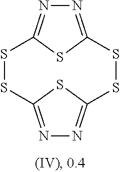 [SMILES: N1=C2SSc3nnc(s3)SSC(=N1)S2] | 3.2 |
| 96 | 20.6 | 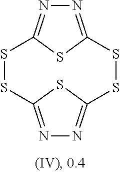 [SMILES: N1=C2SSc3nnc(s3)SSC(=N1)S2] | 1.0 |
| 97 | 70.0 | 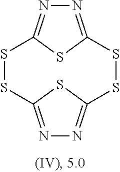 [SMILES: N1=C2SSc3nnc(s3)SSC(=N1)S2] | 10.0 |
| 98 | 74.4 | 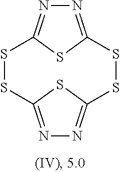 [SMILES: N1=C2SSc3nnc(s3)SSC(=N1)S2] | 6.0 |
| 99 | 85.0 | 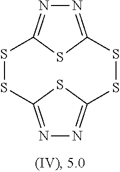 [SMILES: N1=C2SSc3nnc(s3)SSC(=N1)S2] | 4.0 |
| 100 | 94.0 | 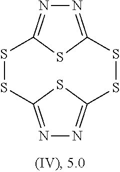 [SMILES: N1=C2SSc3nnc(s3)SSC(=N1)S2] | 1.0 |
| 101 | 65.0 | 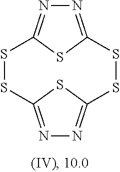 [SMILES: N1=C2SSc3nnc(s3)SSC(=N1)S2] | 10.0 |
| 102 | 70.0 | 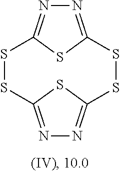 [SMILES: N1=C2SSc3nnc(s3)SSC(=N1)S2] | 6.0 |
| 103 | 80.0 | 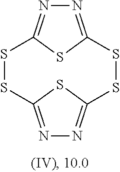 [SMILES: N1=C2SSc3nnc(s3)SSC(=N1)S2] | 4.0 |
| 104 | 89.0 | 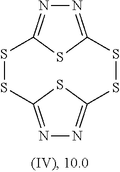 [SMILES: N1=C2SSc3nnc(s3)SSC(=N1)S2] | 1.0 |
| 105 | 55.0 | 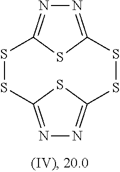 [SMILES: N1=C2SSc3nnc(s3)SSC(=N1)S2] | 10.0 |
| 106 | 60.0 | 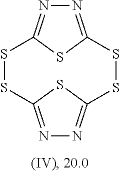 [SMILES: N1=C2SSc3nnc(s3)SSC(=N1)S2] | 6.0 |
| 107 | 70.0 | 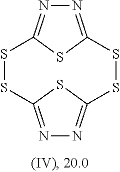 [SMILES: N1=C2SSc3nnc(s3)SSC(=N1)S2] | 4.0 |
| 108 | 79.0 | 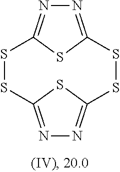 [SMILES: N1=C2SSc3nnc(s3)SSC(=N1)S2] | 1.0 |
| 109 | 50.0 | 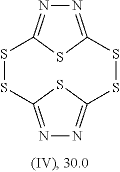 [SMILES: N1=C2SSc3nnc(s3)SSC(=N1)S2] | 10.0 |
| 110 | 55.0 | 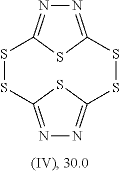 [SMILES: N1=C2SSc3nnc(s3)SSC(=N1)S2] | 6.0 |
| 111 | 60.0 | 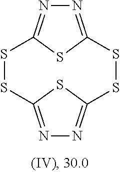 [SMILES: N1=C2SSc3nnc(s3)SSC(=N1)S2] | 4.0 |
| 112 | 69.0 | 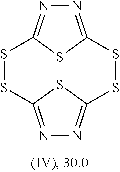 [SMILES: N1=C2SSc3nnc(s3)SSC(=N1)S2] | 1.0 |
| 113 | 74.99 | 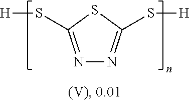 | 10.0 |
| 114 | 84.99 | 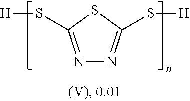 | 6.0 |
| 115 | 89.99 | 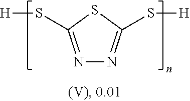 | 4.0 |
| 116 | 98.99 | 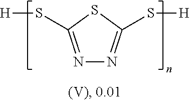 | 1.0 |
| 117 | 74.9 | 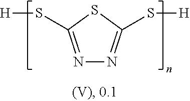 | 10.0 |
| 118 | 84.9 | 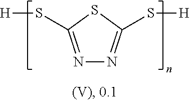 | 6.0 |
| 119 | 89.9 | 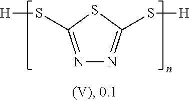 | 4.0 |
| 120 | 98.9 | 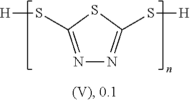 | 1.0 |
| 121 | 74.6 | 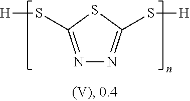 | 10.0 |
| 122 | 50.0 | 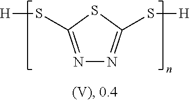 | 6.0 |
| 123 | 8.2 | 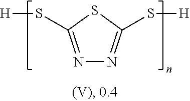 | 3.2 |
| 124 | 20.6 | 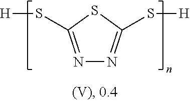 | 1.0 |
| 125 | 70.0 | 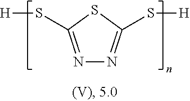 | 10.0 |
| 126 | 74.4 | 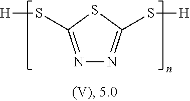 | 6.0 |
| 127 | 85.0 | 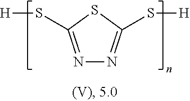 | 4.0 |
| 128 | 94.0 | 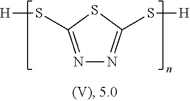 | 1.0 |
| 129 | 65.0 | 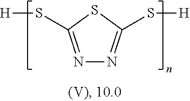 | 10.0 |
| 130 | 70.0 | 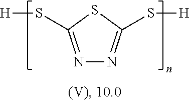 | 6.0 |
| 131 | 80.0 | 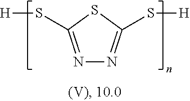 | 4.0 |
| 132 | 89.0 | 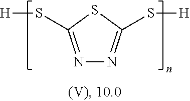 | 1.0 |
| 133 | 55.0 | 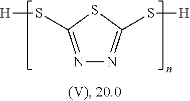 | 10.0 |
| 134 | 60.0 | 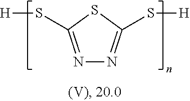 | 6.0 |
| 135 | 70.0 | 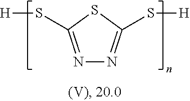 | 4.0 |
| 136 | 79.0 | 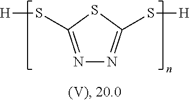 | 1.0 |
| 137 | 50.0 | 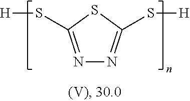 | 10.0 |
| 138 | 55.0 | 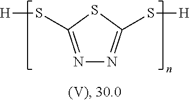 | 6.0 |
| 139 | 60.0 | 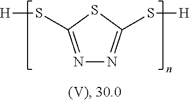 | 4.0 |
| 140 | 69.0 | 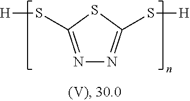 | 1.0 |

37. A method of applying a corrosion inhibitor on a substrate, comprising:
coating the substrate, wherein the coating comprises a corrosion inhibiting formulation according to claim 1; and
curing the coating.

38. The method of claim 37, wherein coating the substrate comprises at least one of dipping, brushing, flow-coating, screen-printing, slot-die coating, gravure coating, powder coating, spraying and spin-coating the coating onto the substrate.

39. The method of claim 37, wherein the curing the coating comprises subjecting the coating to a temperature ranging from about 65° F. to about 160° F.
